(19) United States
(12) Patent Application Publication
(10) Pub. No.: US 2025/0011613 A1
(43) Pub. Date: Jan. 9, 2025

(54) OVER VARNISH COMPOSITION

(71) Applicant: PPG Industries Ohio, Inc., Cleveland, OH (US)

(72) Inventor: Christelle Witt-Sanson, Ofterdingen (DE)

(73) Assignee: PPG Industries Ohio, Inc., Cleveland, OH (US)

(21) Appl. No.: 18/560,775

(22) PCT Filed: May 19, 2022
(86) PCT No.: PCT/US2022/072441

§ 371 Date: Nov. 14, 2023

Related U.S. Application Data
(60) Provisional application No. 63/191,827, filed on May 21, 2021.
(60) Provisional application No. 63/191,808, filed on May 21, 2021.

(51) Int. Cl. C09D 11/54; B65D 65/42; B65D 83/38; C09D 11/101; C09D 11/102

(52) U.S. Cl. CPC C09D 11/54; B65D 65/42; B65D 83/38; C09D 11/101; C09D 11/102

(57) ABSTRACT

A package coated on at least a portion thereof with an over varnish layer, the over varnish layer being derived from an over varnish composition comprising a film-forming resin, a micronized wax, and a micronized polysaccharide; wherein the package may be a monobloc aerosol can or an extruded plastic tube.

### FIELD

The present disclosure relates to a package coated with an over varnish layer. The present disclosure also relates to over varnish compositions, use of a combination of a micronized wax and a micronized polysaccharide to provide an over varnish layer having a desirable scratch resistance or surface slip value, a method of improving the scratch resistance of an over varnish layer, a method of improving the surface slip value of an over varnish layer and a method for coating a package with an over varnish layer.

### BACKGROUND

Cans used for the storage of aerosols, such as personal healthcare aerosols, are usually formed from a tube, such as an aluminium tin-plate or steel tube. One type of such can is a monobloc aerosol can, which is so called because it is formed from a single piece (a small disc known as a “slug”) of aluminium. The surfaces of such cans, as well as the surfaces of extruded plastic tubes, are required to be coated for various reasons.

The external areas of such cans or tubes are often coated in a decorative manner and may allow printing thereon to inform a user as to the contents of the can or tube. The external areas are also often coated with an over varnish layer, which layer provides protection for the underlying substrate whilst also enabling the underlying substrate and/or any other underlying coating(s) to be visible therethrough.

Many over varnish layers currently used for monobloc aerosol cans or extruded plastic tubes contain poly(tetrafluoroethylene) (PTFE) based waxes. Perfluorooctanoic acid (PFOA) is used in the production of PTFE and small quantities of PFOA are often present in PTFE-based waxes. PFOA is carcinogenic and has been linked to cancers and damage to the unborn child.

### SUMMARY

According to the present disclosure, there is provided a package coated on at least a portion thereof with an over varnish layer, the over varnish layer being derived from an over varnish composition comprising a film-forming resin, a micronized wax, and a micronized polysaccharide; wherein the package may be a monobloc aerosol can or an extruded plastic tube.

There is also provided a monobloc aerosol can coated on at least a portion thereof with an over varnish layer, the over varnish layer being derived from an over varnish composition, the over varnish composition comprising a film-forming resin, a micronized wax, and a micronized polysaccharide.

There is also provided an over varnish composition comprising a film-forming resin, a micronized wax, and a micronized polysaccharide, wherein the over varnish composition provides an over varnish layer having a scratch resistance of at least 10 (such as from 10 to 18 or from 12 to 14) revolutions when coated on a substrate and cured thermally. This over varnish composition may be referred to herein as a thermally-curable over varnish composition.

There is also provided an article coated on at least a portion thereof with an over varnish layer, the over varnish layer being derived from the over varnish composition as described herein (which may be referred to as the thermally-curable over varnish composition as described herein).

There is also provided a use of a combination of a micronized wax and a micronized polysaccharide in an over varnish composition comprising a film-forming resin to provide an over varnish layer having a scratch resistance of at least 10 (such as from 10 to 18 or from 12 to 14) revolutions when coated on a substrate and cured thermally.

There is also provided a method of providing an over varnish layer having a scratch resistance of at least 10 (such as from 10 to 18 or from 12 to 14) revolutions when coated on at least a portion of a substrate, the method comprising:
(i) applying a layer of the over varnish composition as described herein (which may be referred to as the thermally-curable over varnish composition as described herein) to at least a portion of the substrate; and
(ii) thermally curing the over varnish composition.

There is also provided a method of improving the scratch resistance of an over varnish layer on at least a portion of a substrate, the method comprising:
(i) applying a layer of the over varnish composition as described herein (which may be referred to as the thermally-curable over varnish composition as described herein) to at least a portion of the substrate; and
(ii) thermally curing the over varnish composition.

There is also provided a method for coating a monobloc aerosol can on at least a portion thereof with an over varnish layer, the method comprising:
(i) applying a layer of the over varnish composition as described herein (which may be referred to as the thermally-curable over varnish composition as described herein) to at least a portion of the can; and
(ii) thermally curing the over varnish composition.

There is also provided an extruded plastic tube coated on at least a portion thereof with an over varnish layer, the over varnish layer being derived from an over varnish composition, the over varnish composition comprising a film-forming resin, a micronized wax and a micronized polysaccharide.

There is also provided an ultraviolet (UV)-curable over varnish composition comprising a film-forming resin, a micronized wax and a micronized polysaccharide.

There is also provided an article coated on at least a portion thereof with an over varnish layer, the over varnish layer being derived from the UV-curable over varnish composition as described herein.

There is also provided a use of a combination of a micronized wax and a micronized polysaccharide in a UV-curable over varnish composition comprising a film-forming resin to improve the surface slip value of an over varnish layer when coated on at least a portion of a substrate and UV cured.

There is also provided a method of improving the surface slip value of an over varnish layer on at least a portion of a substrate, the method comprising:
(i) applying a layer of the UV-curable over varnish composition as described herein to at least a portion of the substrate; and
(ii) UV curing the over varnish composition.

There is also provided a method for coating an extruded plastic tube on at least a portion thereof with an over varnish layer, the method comprising:
(i) applying a layer of the UV-curable over varnish composition as described herein to at least a portion of the tube; and
(ii) UV curing the over varnish composition.

### DETAILED DESCRIPTION

### Package Such as a Coated Monoblock Aerosol can or Extruded Plastic Tube

According to the present disclosure there is provided a package coated on at least a portion thereof with an over varnish layer, the over varnish layer being derived from an over varnish composition comprising a film-forming resin, a micronized wax, and a micronized polysaccharide; wherein the package may be a monobloc aerosol can or an extruded plastic tube.

The over varnish layer (such as when applied to a package, such as a monobloc aerosol can or an extruded plastic tube) may protect the underlying substrate. The over varnish composition is easy to manufacture and avoids the use of undesirable components such as perfluorooctanoic acid, whilst still providing desirable properties (such as scratch resistance or surface slip) in use.

As used herein, the term “package” means anything used to contain another item, particularly for shipping from a point of manufacture to a consumer, and for subsequent storage by a consumer. A package will be therefore understood as something that is sealed so as to keep its contents free from deterioration until opened by a consumer. The manufacturer will often identify the length of time during which the contents will be free from spoilage, which typically ranges from several months to years. A package according to the present disclosure can be made of metal or non-metal, for example, plastic or laminate, and be in any form. An example of a suitable package is a laminate tube. Another example of a suitable package is a food or beverage container, typically in the form of a metal can. The term “metal can” includes any type of metal can, container or any type of receptacle or portion thereof that is sealed by the food/beverage manufacturer to minimize or eliminate spoilage of the contents until such package is opened by the consumer. Example of a metal can is a food can; the term “food can(s)” is used herein to refer to cans, containers or any type of receptacle or portion thereof used to hold any type of food and/or beverage. The term “metal can(s)” specifically includes food cans and also specifically includes “can ends” including “E-Z open ends”, which are typically stamped from can end stock and used in conjunction with the packaging of food and beverages. The term “metal cans” also specifically includes metal caps and/or closures such as bottle caps, screw top caps and lids of any size, lug caps, and the like. The metal cans can be used to hold other items as well, including, but not limited to, personal care products, bug spray, spray paint, and any other compound suitable for packaging in an aerosol can. The cans can include “two piece cans” and “three-piece cans” as well as drawn and ironed one-piece cans; such one piece cans often find application with aerosol products. Packages coated according to the present disclosure can also include plastic bottles, plastic tubes (such as extruded plastic tubes), laminates and flexible packaging, such as those made from PE, PP, PET and the like. Such packaging could hold, for example, food, toothpaste, personal care products and the like.

As used herein, an “over varnish layer” means a cured coating layer which is substantially clear, such that the substrate (e.g. the package, such as a monobloc aerosol can or extruded plastic tube) and/or underlying coating layers are visible therethrough. The over varnish layer may provide a gloss or a matt layer on a substrate. An “over varnish composition” means a coating composition that can be used to provide an over varnish layer, wherein the over varnish layer so provided may be substantially clear.

As used herein, “substantially clear” means that an over varnish layer or an over varnish composition comprises less than 5 wt % pigment, such as less than 3 wt %, such as less than 1 wt %, or even less than 0.5 wt % pigment based on the total solid weight of the over varnish layer or over varnish composition.

As used herein, “the over varnish layer being derived from an over varnish composition” means that the over varnish composition is applied to a substrate and cured, so as to provide an over varnish layer on the substrate.

The package, such as the monobloc aerosol can or the extruded plastic tube, may be coated on at least a portion of an external surface thereof with the over varnish layer. The monobloc aerosol can or the extruded plastic tube may be coated with a coating layer in addition to the over varnish layer. The over varnish layer may be coated on top of a primer or a basecoat and/or an ink layer. The over varnish layer may form a top coat layer, such as over an ink layer.

The over varnish layer may be derived from any over varnish composition as described herein. Thus, features of the over varnish layer as disclosed herein apply equally to the over varnish composition and vice versa.

The over-varnish composition comprises a film-forming resin. The over-varnish composition may comprise any suitable film-forming resin. Suitable film-forming resins are described herein.

As used herein, the term “micronized” takes its usual meaning of particles having D50 values in the micrometer range. For example, the micronized particles may have D50 values of up to 100 μm, such as up to 50 μm, such as up to 30 μm, or up to 10 μm. Micronization may be achieved by any suitable means, which would be well known to persons skilled in the art, including by mechanical means such as milling and grinding. The D50 value may be measured by any suitable method. Methods to measure D50 values will be well known to a person skilled in the art. The D50 values reported herein were measured using a Malvern Mastersizer 2000 laser diffraction testing instrument, as would be well known to persons skilled in the art.

The over varnish composition comprises a micronized wax. As used herein, “wax” means a hydrophobic, malleable solid near ambient temperatures that shows lower viscosity in the melt phase.

The micronized wax may comprise any suitable wax, such as a polyolefin wax, a Fischer-Tropsch wax, a polyamide wax, carnauba wax, and/or paraffin wax.

The micronized wax may comprise a polyolefin wax, such as polyethylene wax and/or polypropylene wax.

The over varnish composition comprises a micronized polysaccharide. The micronized polysaccharide may be in the form of a wax, or may not be a wax. The micronized polysaccharide may comprise a polysaccharide wax. When the micronized polysaccharide comprises a polysaccharide wax, the over varnish composition may comprise an additional micronized wax that does not comprise a polysaccharide. In other words, when the micronized polysaccharide comprises a micronized polysaccharide wax, the over varnish composition may further comprise an additional micronized wax, such as a polyolefin wax, a Fischer-Tropsch wax, a polyamide wax, carnauba wax, and/or paraffin wax (for example a polyolefin wax) as described herein.

The micronized polysaccharide may comprise any suitable micronized polysaccharide, such as a polysaccharide comprising glucose units (such as glucose monomers linked by a glycosidic bonds). The micronized polysaccharide may comprise starch, glycogen, cellulose, cellulose, chitosan, chitin, amylose and/or sugar-cane (such as starch, glycogen, cellulose, cellulose, chitosan, chitin and/or amylose).

The weight ratio of the micronized wax to the micronized polysaccharide may be at least 95:5, such as at least 90:10. The weight ratio of the micronized wax to the micronized polysaccharide may be up to 5:95, such as up to 80:20. The weight ratio of the micronized wax to the micronized polysaccharide may be from 95:5 to 5:95, such as from 90:10 to 80:20.

The micronized wax and micronized polysaccharide may be included in the over varnish composition as separate components or as an additive composition that comprises the micronized wax and micronized polysaccharide (for example wherein the micronized wax and micronized polysaccharide are pre-mixed to form the additive composition). The additive composition may comprise the micronized wax and micronized polysaccharide, such as wherein the wax and polysaccharide is processed and/or micronized prior to use to provide the desired particles sizes.

The over varnish composition may be substantially free, such as essentially free or completely free, of perfluorooctanoic acid and derivatives thereof. By “substantially free” in relation to perfluorooctanoic acid and derivatives thereof we mean that the over varnish compositions (and over varnish layers derived therefrom) contain less than 1000 parts per million (ppm) of perfluorooctanoic acid and derivatives thereof. By “essentially free” we mean that the over varnish compositions (and over varnish layers derived therefrom) contain less than 100 ppm of perfluorooctanoic acid and derivatives thereof. By “completely free” we mean that the over varnish compositions (and over varnish layers derived therefrom) contain less than 20 parts per billion (ppb) of perfluorooctanoic acid and derivatives thereof. Derivatives of perfluorooctanoic acid include polytetrafluoroethylene. It is desirable to reduce levels of perfluorooctanoic acid, as perfluorooctanoic acid has been associated with various health risks.

The over varnish compositions according to the present disclosure may be substantially free of bisphenol A (BPA) and derivatives thereof. The over varnish compositions according to the present disclosure may be essentially free or may be completely free of bisphenol A (BPA) and derivatives thereof. Derivatives of bisphenol A include, for example, bisphenol A diglycidyl ether (BADGE).

The over varnish compositions according to the present disclosure may be substantially free of bisphenol F (BPF) and derivatives thereof. The over varnish compositions according to the present disclosure may be essentially free or may be completely free of bisphenol F (BPF) and derivatives thereof. Derivatives of bisphenol F include, for example, bisphenol F diglycidyl ether (BFDGE).

The compounds or derivatives thereof mentioned above, i.e. BPA, BPF and derivatives thereof, may not be added to the composition intentionally but may be present in trace amounts because of unavoidable contamination from the environment. By “substantially free” we mean to refer to over varnish compositions (and over varnish layers derived therefrom) containing less than about 1000 parts per million (ppm) of any of the compounds or derivatives thereof mentioned above. By “essentially free” we mean to refer to over varnish compositions (and over varnish layers derived therefrom) containing less than about 100 ppm of any of the compounds or derivatives thereof mentioned above. By “completely free” we mean to refer to over varnish compositions (and over varnish layers derived therefrom) containing less than about 20 parts per billion (ppb) of any of the compounds or derivatives thereof.

The over varnish composition may comprise other optional materials well known in the art of formulating coatings, such as defoamers, surface additives, crosslinkers, catalysts, matting agents, wetting agents, levelling agents, plasticizers, abrasion-resistant particles, anti-oxidants, hindered amine light stabilizers, UV light absorbers and stabilizers, surfactants, flow control agents, thixotropic agents, fillers, organic co-solvents, reactive diluents, grind vehicles, lubricants, and other customary auxiliaries.

The over-varnish composition may be applied to the package (such as the monobloc aerosol can or extruded plastic tube) by any suitable method. Such methods will be well known to a person skilled in the art.

The over varnish composition may be applied to any suitable dry film thickness. The over varnish composition may be applied to a dry film thickness up to 15 microns (μm), such as up to 10 μm, such as up to 5 μm, or even up to 1 μm. The over varnish composition may be applied to a dry film thickness from 0.5 to 15 microns (μm), such as from 0.5 to 10 μm, such as from 0.5 to 5 μm, or even from 0.5 to 1 μm.

The over varnish composition may be applied to a substrate, or a portion thereof, as a single layer or as part of a multi-layer system. The over varnish composition may be applied as a single layer, i.e. to form an over varnish layer. The over varnish composition may be applied to an uncoated substrate. For the avoidance of doubt an uncoated substrate extends to a surface that is cleaned prior to application. The over varnish composition may be applied on top of another paint layer as part of a multi-layer system. For example, the over varnish composition may be applied on top of a primer or an intermediate layer. The over varnish compositions may form a top coat (over varnish) layer. If a further layer is applied to the substrate after the over varnish layer, then this may comprise a coating composition that may be thermally cured at a temperature of up to 200° C., such as from 80 to 200° C.

The over varnish compositions may be applied to a substrate once or multiple times.

The over varnish layer may be derived from any over varnish composition as described herein. Thus, features of the over varnish layer(s) as disclosed herein apply equally to the over varnish composition(s) and vice versa.

### Coated Monobloc Aerosol can and Over-Varnish Composition for Application to a Monobloc Aerosol can

The present disclosure may provide a coated monobloc aerosol can. Thus, according to the present disclosure there is provided a monobloc aerosol can coated on at least a portion thereof with an over varnish layer, the over varnish layer being derived from an over varnish composition comprising a film-forming resin, a micronized wax, and a micronized polysaccharide.

According to the present disclosure there is provided an over varnish composition comprising a film-forming resin, a micronized wax, and a micronized polysaccharide, wherein the over varnish composition provides an over varnish layer having a scratch resistance of at least 10 (such as from 10 to 18 or from 12 to 14) revolutions when coated on a substrate and cured thermally. This over varnish composition may be referred to as a thermally-curable over varnish composition. This over varnish composition is suitable for application to a monobloc aerosol can.

The over varnish layer when applied to a substrate such as a monobloc aerosol can may protect the underlying substrate. The over varnish composition is easy to manufacture and avoids the use of undesirable components such as perfluorooctanoic acid, whilst still providing desirable properties (such as scratch resistance) in use.

References herein to an over varnish composition “for a monobloc aerosol can” refer to a composition comprising components as described herein that provide a composition, such as a thermally-curable composition, suitable for application to a monobloc aerosol can.

The monobloc aerosol can may contain any suitable product, such as a personal care product (such as deodorant or hair spray), bug spray, spray paint, and any other compound suitable for packaging in an aerosol can. The monobloc aerosol can may be an aluminium or steel monobloc aerosol can, such as a tin-coated aluminium or tin-coated steel monobloc aerosol can.

The monobloc aerosol can may be coated on at least a portion of an external surface thereof with the over varnish layer. The monobloc aerosol can may be coated with a coating layer in addition to the over varnish layer. The over varnish layer may be coated on top of a primer or a basecoat and/or an ink layer. The over varnish layer may form a top coat layer, such as over an ink layer.

The over varnish composition (which may be referred to as the thermally-curable over varnish composition) comprises a suitable film-forming resin. The film-forming resin may comprise a functionalised resin such that the resin comprises functional groups operable to react with a crosslinker so as to allow the resin to crosslink. Suitable such functional groups include epoxy, ester, amide, keto, vinyl, hydroxyl and/or carboxyl groups or any combination thereof. The film-forming resin may comprise a polyester resin, a polyol resin, a polyurethane resin, an epoxy resin, and/or an acrylic resin.

The film-forming resin may comprise a polyester resin. As used herein, a polyester means a polymer having 2 or more ester groups within the polymer backbone. The polyester resin may comprise additional functional groups (such as terminal or pendant functional groups), such as hydroxyl, carboxyl and/or epoxy functional groups. The polymer backbone may be linear or branched.

The polyester resin may comprise the reaction product of a polyacid and a polyol.

“Polyacid” and like terms, as used herein, refers to a compound having two or more carboxylic acid groups, such as two, three or four acid groups, and includes an ester of the polyacid (wherein an acid group is esterified) or an anhydride. The polyacid may be an organic polyacid.

The carboxylic acid groups of the polyacid may be connected by a bridging group selected from: an alkylene group; an alkenylene group; an alkynylene group; or an arylene group.

The polyester resin may be formed from any suitable polyacid, such as maleic acid; fumaric acid; itaconic acid; adipic acid; azelaic acid; succinic acid; sebacic acid; glutaric acid; decanoic diacid; dodecanoic diacid; phthalic acid; phthalic anhydride; isophthalic acid; 5-tert-butylisophthalic acid; tetrachlorophthalic acid; tetrahydrophthalic acid; trimellitic acid; trimellitic anhydride; naphthalene dicarboxylic acid; naphthalene tetracarboxylic acid; terephthalic acid; hexahydrophthalic acid; methylhexahydrophthalic acid; dimethyl terephthalate; cyclohexane dicarboxylic acid; chlorendic anhydride; 1,3-cyclohexane dicarboxylic acid; 1,4-cyclohexane dicarboxylic acid; tricyclodecane polycarboxylic acid; endomethylene tetrahydrophthalic acid; endoethylene hexahydrophthalic acid; cyclohexanetetracarboxylic acid; cyclobutane tetracarboxylic acid; esters and/or anhydrides of all the aforementioned acids and combinations thereof.

“Polyol” and like terms, as used herein, refers to a compound having two or more hydroxyl groups, such as two, three or four hydroxyl groups. The hydroxyl groups of the polyols may be connected by a bridging group selected from: an alkylene group; an alkenylene group; and alkynylene group; or an arylene group. The polyol may be an organic polyol.

The polyester resin may be formed from any suitable polyols, such as alkylene glycols, such as ethylene glycol; propylene glycol; diethylene glycol; dipropylene glycol; triethylene glycol; tripropylene glycol; hexylene glycol; polyethylene glycol; polypropylene glycol and neopentyl glycol; cyclohexanediol; propanediols including 1,2-propanediol; 1,3-propanediol; butyl ethyl propanediol; 2-methyl-1,3-propanediol; and 2-ethyl-2-butyl-1,3-propanediol; butanediols including 1,4-butanediol; 1,3-butanediol; and 2-ethyl-1,4-butanediol; pentanediols including trimethyl pentanediol and 2-methylpentanediol; cyclohexanedimethanol; hexanediols including 1,6-hexanediol; caprolactonediol (such as the reaction product of epsilon-caprolactone and ethylene glycol); polyether glycols, such as poly(oxytetramethylene) glycol; trimethylol butane; trimethylol propane; dimethylol cyclohexane; glycerol and the like or combinations thereof.

The polyester resin may comprise polymers or copolymers formed from the reaction of diols and diacids; polyols or polyacid components may optionally be used to produce branched polymers.

The polyacids which can optionally be used to produce branched polymers include, but are not limited to, the following: trimellitic anhydride; trimellitic acid; pyromellitic acid; esters and anhydrides of all the aforementioned acids; and mixtures thereof.

The polyols which can optionally be used to produce branched polymers include, but are not limited to the following: glycerine; trimethylol propane; trimethylol ethane; 1,2,6 hexane triol; pentaerythritol; erythritol; di-trimethylol propane; di-pentaerythritol; N,N,N′,N′ tetra (hydroxyethyl)adipindiamide; N,N,N′N′ tetra (hydroxypropyl)adipindiamide; other, primarily hydroxyl, functional branching monomers; or mixtures thereof.

The polyester resin may be formed from any suitable molar ratio of polyacid:polyol. The molar ratio of polyacid:polyol in the polyester resin may be at least 20:1, such as at least 10:1, such as at least 5:1, or even at least 2:1. The molar ratio of polyacid:polyol in the polyester resin may be up to 1:20, such as up to 1:10, such as up to 1:5, or even up to 1:2. The molar ratio of polyacid:polyol in the polyester resin may be from 20:1 to 1:20, such as from 10:1 to 1:10, such as from 5:1 to 1:5, or even from 2:1 to 1:2. The molar ratio of polyacid:polyol in the polyester resin may be 1:1.

The polyester resin may be formed from any suitable molar ratio of diacid:diol. The molar ratio of diacid:diol in the polyester resin may be at least 10:1, such as at least 5:1, such as at least 3:1, or even at least 2:1. The molar ratio of diacid:diol in the polyester resin may be up to 1:10, such as up to 1:5, such as up to 1:3, or even from 2:1 to 1:2. The molar ratio of diacid:diol in the polyester resin may be from 10:1 to 1:10, such as from 5:1 to 1:5, such as from 3:1 to 1:3, or even from 2:1 to 1:2.

The molar ratio of diacid:diol in the polyester resin may be at least 1.5:1, such as at least 1.2:1 or even at least 1.1:1. The molar ratio of diacid:diol in the polyester resin may be up to 1:1.5, such as up to 1:1.2 or even up to 1:1.1. The molar ratio of diacid:diol in the polyester resin may be from 1.5:1 to 1:1.5, such as from 1.2:1 to 1:1.2 or even from 1.1:1 to 1:1.1.

The polyester resin may optionally be formed from any suitable molar ratio of diacid+diol to polyacid and/or polyol. The polyester resin may comprise a molar ratio of diacid+diol to polyacid and/or polyol of at least 100:1. The polyester resin may comprise a molar ratio of diacid+diol to polyacid and/or polyol of up to 1:1, such as up to 5:1, such as up to 20:1, or even up to 50:1. The polyester resin may comprise a molar ratio of diacid+diol to polyacid and/or polyol of from 100:1 to 1:1, such as from 100:1 to 5:1, such as from 100:1 to 20:1, or even from 100:1 to 50:1.

The polyester resin may optionally be formed from an additional monomer, such as a monoacid or monohydric alcohol or combinations thereof. The optional additional monomer may be organic.

The polyester resin may optionally be formed from an additional monoacid. ‘Monoacid’ and like terms, as used herein, refers to compounds having one carboxylic acid group and includes an ester of the monoacid (where the acid group is esterified) or an anhydride. The monoacid may be an organic monoacid.

The polyester resin may optionally be formed from any suitable additional monoacid, such as benzoic acid; cyclohexane carboxylic acid; tricyclodecane carboxylic acid; camporic acid; benzoic acid; t-butyl benzoic acid; C₁-C₁₈ aliphatic carboxylic acids such as acetic acid; propanoic acid; butanoic acid; hexanoic acid; oleic acid; linoleic acid; undecanoic acid; lauric acid; isononanoic acid; fatty acids; hydrogenated fatty acids of naturally occurring oils; esters and/or anhydrides of any of the aforementioned acids and combinations thereof.

The polyester resin may optionally be formed from an additional monohydric alcohol. ‘Monohydric alcohol’ and like terms as used herein, refers to compounds having one hydroxyl group. The monohydric alcohol may be an organic monohydric alcohol.

The polyester resin may optionally be formed from any suitable additional monohydric alcohol, such as benzyl alcohol; hydroxyethoxybenzene; methanol; ethanol; propanol; butanol; pentanol; hexanol; heptanol; dodecyl alcohol; stearyl alcohol; oleyl alcohol; undecanol; cyclohexanol; phenol; phenyl carbinol; methylphenyl carbinol; cresol; monoethers of glycols; halogen-substituted or other substituted alcohols and combinations thereof.

The polyester resin may optionally be formed from any suitable molar ratio of polyacid+polyols:additional monomer. The polyester resin may comprise a molar ratio of polyacid+polyols:additional monomer of at least 100:1. The polyester resin may comprise a molar ratio of polyacid+polyols:additional monomer of up to 1:1, such as up to 5:1, such as up to 20:1, or even up to 50:1. The polyester resin may comprise a molar ratio of polyacid+polyols:additional monomer of from 100:1 to 1:1, such as from 100:1 to 5:1, such as from 100:1 to 20:1, or even from 100:1 to 50:1.

The polyester resin according to the present disclosure may be prepared in the presence of an esterification catalyst. The esterification catalyst may be chosen to promote the reaction of components by esterification and trans-esterification. The esterification catalyst may comprise a metal compound such as stannous octoate; stannous chloride; butyl stannoic acid (hydroxy butyl tin oxide); monobutyl tin tris (2-ethylhexanoate); chloro butyl tin dihydroxide; tetra-n-propyl titanate; tetra-n-butyl titanate; zinc acetate; an acid compound such as phosphoric acid; para-toluene sulphonic acid (such as Nacure 2547 commercially available from King Industries); dodecyl benzene sulphonic acid (DDBSA) or combinations thereof. The esterification catalyst may comprise para-toluene sulphonic acid and/or dodecyl benzene sulphonic acid (DDBSA).

The esterification catalyst, when present, may be used in amounts of at least 0.001% by weight based on total polymer components, such as at least 0.01 or at least 0.025% by weight based on total polymer components. The esterification catalyst, when present, may be used in amounts up to 1% by weight based on total polymer components, such as up to 0.2% by weight based on total polymer components. The esterification catalyst, when present, may be used in amounts from 0.001 to 1% by weight on total polymer components, such as from 0.01 to 0.2%, such as from 0.025 to 0.2% by weight on total polymer components. The esterification catalyst may be present in the over varnish composition.

The polyester resin according to the present disclosure may be prepared in the presence of a molecular weight increasing agent. By “molecular weight increasing agent” we mean a substance that increases the number-average molecular weight (Mn) of the polyester resin. The molecular weight increasing agent may be any suitable compound capable of increasing the Mn of the polyester resin. The molecular weight increasing agent may comprise a polyacid, a polyol or combinations thereof. The molecular weight increasing agent may comprise a polyacid. The molecular weight increasing agent may comprise a diacid.

Suitable polyester resins include Uradil™ SZ255 G3Z-65, Uradil™ SZ261 G3Z-65, Uralac® 8811-X70, Uralac® 8815 S70, Uralac® 8830 S60, Uralac® SN802 DS2-50 ND, Uralac® SN808 DS2-G3 ND, Uralac® SN908 DS2-50 ND (commercially available from DSM Resins), Desmophen 1200, Desmophen 1700 (commercially available from Covestro), Dynapol® LH 830, Dynapol® LH 775, Dynapol® LH 815, Dynapol® LH 538 (commercially available from Evonik Industries), Resydrol® AN 6617w/65MPP, Resydrol® AN 6481w/70BBP, Setal®186 SS-65, Setal®26-1056, Setal 26-1089 (commercially available from Allnex), Italester H27, Italester H28, Italester 300, Italester 242, Italester 226, Italester 251 (commercially available from Galstaff Multiresine), Lupraphen 1600/4, Lupraphen 1608/4, Lupraphen 1622/1, Lupraphen 5608/1, Lupraphen 5606/1, Lupraphen 2602/1, Lupraphen 2600/2 (commercially available from BASF).

The film-forming resin may comprise a polyol resin. As used herein, a polyol means a polymer having a hydroxyl functionality of at least 2. The hydroxyl groups may be terminal or found within the polymer chain, or a combination thereof. The polymer backbone may comprise additional functionality, such as a polyether, polyester, polyurethane or any combination thereof. The polymer backbone may be linear or branched. Suitable polyol resins include Ingevity Capa 2043, Ingevity Capa 2100, Ingevity Capa 3301, Ingevity Capa 3031 (commercially available from Ingevity), JEFFOL® PPG-400, JEFFOL® PPG-1000, JEFFOL® PPG-2000, JEFFOL® PPG-2801, JEFFOL® PPG-3703, JEFFOL® PPG-3706, JEFFOL® PPG-3709, JEFFOL® FC31-56, JEFFOL® G31-43 (commercially available from Huntsman Corporation), Pluracol 1010, Pluracol 2010, Pluracol 628, Pluracol 1016, Pluracol 1158, Pluracol 2100, Pluracol 380, Pluracol 1168, Pluracol 736 (commercially available from BASF), VORANOL™ 6150 Polyol, VORANOL™ 2000LM Polyol, VORANOL™ 1000LM Polyol, VORANOL™ 8136 Polyol, VORANOL™ CP 6055 (commercially available from DOW), Lupraphen 1602/1, Lupraphen 1608/2, Lupraphen 2605/1 (commercially available from BASF), Desmophen® 1800, Desmophen® 1200, Desmophen® 670 BA, Desmophen®2060 BD, Desmophen® C 1200 (commercially available from Covestro).

The film-forming resin may comprise a polyurethane resin. As used herein, a polyurethane means a polymer with 2 or more urethane linkages within the backbone. The terminal functionality may include hydroxyl, acid and/or amine functionality. The polyurethane resin may also contain co-functionality within the polymer backbone, such as polyester and/or polyether functionality. Suitable polyurethane resins include DAOTAN® TW 642540WA, DAOTAN® TW 6450/30WA, DAOTAN® VTW 1225/40WA (commercially available from Allnex), Baybond® PU 330, Baybond® PU 401A, Baycusan® C 1000/1, Baycusan® C 1010, Bayhydrol® U 2698, Bayhydrol® U 2750, Desmocoll® 176, Desmocoll® 400/1, Desmolac® 2100 (commercially available from Covestro), NeoRez® U-371, NeoRez® U-397, Uraflex EU220 M1 (commercially available from DSM).

The film-forming resin may comprise an epoxy resin. As used herein an epoxy resin is a polymer with 2 or more epoxy, oxirane and/or glycidyl ether functional groups. The epoxy functional groups may be terminal or contained within a substructure of the polymer backbone. The epoxy resin may be formed from bisphenol, cycloaliphatic or derivatives thereof. Suitable examples include D.E.R.™ 331, D.E.R.™ 351, D.E.R.™ 354, D.E.R.™ 3572, D.E.R.™ 915, D.E.R.™ 900, D.E.N.™ 425, D.E.N.™ 431 (commercially available from DOW), ARALDITE® GY 260, ARALDITE® GY 240, ARALDITE® PY 306, ARALDITE® ECN 1400 (commercially available from Huntsman Corporation), EPI-REZ Resin WD-510, EPI-REZ Resin 7510-W-60, EPON Resin 828, EPON Resin 869 (commercially available from Hexion).

The film-forming resin may comprise an polyacrylate resin, which may also be referred to herein as a polyacrylate (co)polymer or an acrylic (co)polymer. A polyacrylate (co)polymer may be formed from a C₁ to C₆ alkyl (C₀ to C₁ alk) acrylate monomer unit. The C₁ to C₆ alkyl (C₀ to C₁ alk) acrylate monomer unit may comprise (meth)acrylic acid, methyl (meth)acrylate; ethyl (meth)acrylate; propyl (meth)acrylate; butyl (meth)acrylate. The C₁ to C₆ alkyl (C₀ to C₁ alk) acrylate may comprise a functional group, such as an epoxy group, hydroxyl group or alkoxy methyl ether. A C₁ to C₆ alkyl (C₀ to C₁ alk) acrylate may comprise glycidyl methacrylate, hydroxy ethyl acrylate, hydroxyethyl methacrylate or n-butoxymethylacrylamide. The reaction mixture may further comprise an ethylenically unsaturated monomer. The reaction mixture may comprise an aryl substituted ethylenically unsaturated monomer, such as styrene, for example.

Suitable polyacrylate (co)polymers may comprise a hydroxyl or acid functional solution acrylic resin such as Paraloid AT-746, Paraloid AT-63 Paraloid AT-81, Paraloid AT-147 Paraloid AT-85 or Paraloid AT-9L0 from Dow Chemical and/or a polymer such as Synocryl 7013 SD50 from Arkema. The polyacrylate (co)polymer may comprise an acrylic homopolymer or copolymer. Various acrylic monomers can be combined to prepare the acrylic (co)polymer used in the present disclosure. Examples include methyl(meth)acrylate, ethyl(meth)acrylate, butyl(meth)acrylate, hydroxy alkyl(meth)acrylate, 2-ethylhexyl(meth)acrylate, behenyl(meth)acrylate, lauryl(meth)acrylate, allyl(meth)acrylate isobornyl(meth)acrylate, ethylene glycol di(meth)acrylate, (meth)acrylic acid, vinyl aromatic compounds such as styrene and vinyl toluene, nitrites such as (meth)acrylonitrile, and vinyl ester such as vinyl acetate. Any other acrylic monomers known to those skilled in the art could also be used.

The term “(meth)acrylate” and like terms are used conventionally and herein to refer to both methacrylate and acrylate.

Suitable film-forming resins can also include copolymers of polyacrylates with polyester materials. For example, the polyester and acrylate copolymer can be in the formation of a graft copolymer. A graft copolymer can be formed using techniques standard in the art. In one method, the polyester is prepared according to conventional methods using the materials described above. The acrylic monomers are then added to the polyester. The acrylic can then be polymerized using a standard free radical initiator. In this manner, the acrylate copolymer is grafted to the already-made polyester. Alternatively, the polyester can be grafted to an already-made acrylic copolymer, for example a maleic anhydride group may be polymerized in the acrylic copolymer and, subsequently, hydroxyl groups from the polyester can be allowed to react with the acrylic to create a graft copolymer; the result will be an acrylic copolymer having polyester moieties grafted thereto. In the methods for grafting, one selects a moiety to be incorporated into the polyester and a monomer to be included with the acrylate monomers that will react with each other. Maleic anhydride may be used in the formation of a polyester and styrene as one of the acrylic monomers. The styrene will react with the maleic anhydride; the acrylic copolymer will grow off of the styrene through the formation of free radicals. The result will be a polyester having acrylic copolymers grafted thereto. It will be appreciated that not all of the acrylic and polyester will graft; thus, there will be some “neat” polyester and some “neat” acrylate copolymer in the solution. Enough of the acrylate copolymer and polyester will graft, however, to compatibilize the two normally incompatible polymers. It will be appreciated that maleic anhydride and styrene are offered as examples of two components that will promote grafting between the normally incompatible polymers, but that the copolymers are not so limited. Other compounds such as fumaric acid/anhydride or itaconic acid/anhydride may be incorporated into a polyester for grafting with a styrene containing acrylic. Other moieties that will promote grafting between the polyester and acrylic can also be used. Any group of compounds can be used for this purpose. All of these compounds are referred to herein as “graft promoting components”. The amount of graft promoting component used in each of the polyester and/or acrylate portions can affect the final product. If too much of these components are used, the product can gel or be otherwise unusable. The graft-promoting components should therefore be used in an amount effective to promote grafting but not to cause gelling. Enough grafting should be effected to allow the polyester and acrylate polymers to be compatible. In the maleic anhydride/styrene example, usually 2 to 6 weight percent maleic with 8 to 30 weight percent styrene can be used, with weight percent being based on the weight of the polyester and the weight of the acrylic, respectively.

The over varnish composition (which may be referred to as the thermally-curable over varnish composition) may comprise at least 40 wt %, such as at least 45 wt %, such as at least 48 wt % of the film-forming resin based on the total solid weight of the over varnish composition. The over varnish composition may comprise up to 80 wt %, such as up to 70 wt %, such as up to 55 wt % of the film-forming resin based on the total solid weight of the over varnish composition. The over varnish composition may comprise from 40 to 80 wt % of the film-forming resin based on the total solid weight of the over varnish composition. The over varnish composition may comprise from 45 to 70 wt %, such as from 48 to 55 wt % of the film-forming resin based on the total solid weight of the over varnish composition.

The over varnish composition (which may be referred to as the thermally-curable over varnish composition) comprises a micronized wax. The micronized wax may comprise any suitable wax, such as a polyolefin wax, a Fischer-Tropsch wax, a polyamide wax, carnauba wax, and/or paraffin wax. The micronized wax may comprise a polyolefin wax, such as polyethylene wax and/or polypropylene wax.

The over varnish composition (which may be referred to as the thermally-curable over varnish composition) comprises a micronized polysaccharide. The micronized polysaccharide may be in the form of a wax, or may not be a wax. The micronized polysaccharide may comprise a polysaccharide wax. When the micronized polysaccharide comprises a polysaccharide wax, the over varnish composition may comprise an additional micronized wax that does not comprise a polysaccharide. In other words, when the micronized polysaccharide comprises a micronized polysaccharide wax, the over varnish composition may further comprise an additional micronized wax, such as a polyolefin wax, a Fischer-Tropsch wax, a polyamide wax, carnauba wax, and/or paraffin wax (for example a polyolefin wax) as described herein.

The micronized polysaccharide may comprise any suitable micronized polysaccharide, such as a polysaccharide comprising glucose units (such as glucose monomers linked by a glycosidic bonds). The micronized polysaccharide may comprise starch, glycogen, cellulose, cellulose, chitosan, chitin, amylose and/or sugar-cane (such as starch, glycogen, cellulose, cellulose, chitosan, chitin and/or amylose).

The weight ratio of the micronized wax to the micronized polysaccharide may be at least 95:5, such as at least 90:10. The weight ratio of the micronized wax to the micronized polysaccharide may be up to 5:95, such as up to 80:20. The weight ratio of the micronized wax to the micronized polysaccharide may be from 95:5 to 5:95, such as from 90:10 to 80:20.

The micronized wax and micronized polysaccharide may be included in the over varnish composition as separate components or as an additive composition that comprises the micronized wax and micronized polysaccharide (for example wherein the micronized wax and micronized polysaccharide are pre-mixed to form the additive composition). The additive composition may comprise the micronized wax and micronized polysaccharide, such as wherein the wax and polysaccharide is processed and/or micronized prior to use to provide the desired particles sizes.

The over varnish composition (which may be referred to as the thermally-curable over varnish composition) may comprise a solvent, and may be a water-borne or a solvent-borne composition.

When the over varnish composition is a water-borne composition, the composition may comprise water as a solvent, such that the majority of the solvent in the over varnish composition is water, i.e. such that the over varnish composition comprises less than 20 wt %, such as less than 15 wt %, such as less than 12 wt %, of an organic (i.e. non-aqueous) solvent based on the total weight of the over varnish composition.

When the over varnish composition is a water-borne composition, the composition may comprise a solvent, wherein the majority of the solvent is water, i.e. such that the solvent comprises less than 35 wt %, such as less than 30 wt %, such as less than 27 wt %, of an organic (i.e. non-aqueous) solvent based on the total weight of the solvent in the over varnish composition.

When the over varnish composition is solvent-borne, the composition may comprise an organic (i.e. non-aqueous) solvent, such that the majority of the solvent in the over varnish composition is an organic solvent, i.e. such that the over varnish composition comprises less than 10 wt %, such as less than 5 wt %, such as less than 2 wt %, of water based on the total weight of the over varnish composition.

The over varnish composition may comprise at least 20 wt %, such as at least 25 wt %, such as at least 30 wt %, of solvent (water or organic solvent) based on the total weight of the over varnish composition. The over varnish composition may comprise up to 60 wt %, such as up to 52 wt %, of solvent (water or organic solvent) based on the total weight of the over varnish composition. The over varnish composition may comprise from 20 to 60 wt %, such as 25 to 60 wt %, such as 30 to 52 wt %, of solvent (water or organic solvent) based on the total weight of the over varnish composition.

When the over varnish composition comprises an organic solvent, any suitable organic solvent may be used. A suitable organic solvent may comprise an alcohol, ester, ketone, glycol, glycol ether, glycol ether ester, aromatic hydrocarbon, aliphatic hydrocarbon, and/or a derivative thereof, such as diethylene glycol monobutylether, di(propylene glycol) methyl ether, 2-butoxyethanol, xylene, toluene, aromatic solvent 100, aromatic solvent 150, 2-butoxyethyl acetate, 2-(2-butoxyethoxy)ethyl acetate, ethyl acetate, n-propyl acetate, n-butyl acetate, isobutyl acetate, n-butyl alcohol, isobutyl alcohol, 1-methoxy-2-propyl acetate, n-propyl alcohol, cyclohexanone, cyclopentanone, methyl-isobutyl ketone, and/or 2-butanone.

The over varnish composition (which may be referred to as the thermally-curable over varnish composition) may further comprise a crosslinker.

The crosslinker may comprise a chemical group suitable for crosslinking the film-forming resin. For example, the crosslinker may comprise: a hydroxyl substituted aromatic group; an isocyanate group; an amino group; an amine group; a urea-formaldehyde and/or an alkylated urea with imino functionality. The crosslinker may comprise an amino group. The cross linker may be in the form of a single molecule, a dimer, an oligomer, a (co)polymer or a mixture thereof.

The crosslinker may comprise a hydroxyl substituted aromatic group, the crosslinker may comprise a di-hydroxyl substituted aromatic group.

Suitable isocyanate containing crosslinkers may comprise IPDI (isophorone diisocyanate) like Desmodur VP-LS 2078/2 or Desmodur PL 340 (Desmodur crosslinkers commercially available from Covestro) or Vestanat B 1370 or Vestanat B1358A (Vestanat crosslinkers commercially available from Evonik) or blocked aliphatic polyisocyanate based on HDI like Desmodur BL3370 or Desmodur BL 3175 SN (commercially available from Covestro) or Duranate MF-K60X (commercially available from Asahi KASEI) or Tolonate D2 (commercially available from Vencorex Chemicals) and/or Trixene-BI-7984 or Trixene 7981 (commercially available from Lanxess).

Suitable water thinnable isocyanate cross linkers may comprise Bayhydur® BL2781, Bayhydur® BL5140, Bayhydur® 2655 (commercially available from Covestro), Aqualink X, and/or Aqualink U-HT (commercially available from Aquaspersions).

Suitable amino containing crosslinkers may comprise a Melamine formaldehyde type material of the hexakis(methoxymethyl)melamine (HMMM) type such as Komelol 90GE (commercially available from Melamin), Maprenal MF900 (commercially available from Prefere Melamines) or Resimene 745 or Resimene 747 (commercially available from Prefere Melamines) or Cymel 303 and/or Cymel MM100 (commercially available from Allnex). Other melamine formaldehyde type material such as butylated methylol melamine type resins such as Cymel 1156 or Cymel 1158 (commercially available from Allnex) or mixed ether type methylal melamine resins such as Cymel 1116, Cymel 1130, Cymel 1133 or Cymel 1168 (commercially available from Allnex) or part methylolated and part methalated melamine type resins such as Cymel 370, Cymel 325 or Cymel 327 (commercially available from Allnex).

Other types of suitable amino containing crosslinkers may comprise a benzoguanamine formaldehyde type material such as Cymel 1123 (commercially available from Allnex), Itamin BG143 (commercially available from Galstaff Multiresine) or Maprenal (Uramex) BF891 and/or Maprenal BF892 (commercially available from Prefere). Further examples of suitable amino containing crosslinking agents include glycouril based materials such as Cymel 1170 and Cymel 1172 (commercially available from Allnex).

Suitable urea-formaldehyde containing crosslinkers may comprise Cymel U-80 or Cymel U-60 (commercially available from Allnex), Maprenal UF 264 (commercially available from Prefere), Astro Set 90 (commercially available from Momentive), Curazine 42-316 or Curazine 42-338 or Curazine 42-360 or Curazine 42-365 or Curazine 42-367 and/or Curazine 42-378 (commercially available from Bitrez).

When the resin comprises an epoxy resin, the crosslinker may have amine functionality that can crosslink with the epoxy resin.

Suitable amine containing crosslinkers may comprise Triethylenetetramine (commercially available from Dow), Aradur 115 BD, 125BD, 140BD (commercially available from Huntsman), dicyandiamide (commercially available from AlzChem) and/or CASAMID DMPFF.

The cross linker, when present, may be used in the over varnish composition in any suitable amount. The cross linker, when present, may be used in amounts of at least 30 wt %, such as at least 35 wt % based on the total solid weight of the over varnish composition. The cross linker, when present, may be used in amounts up to 50 wt %, such as up to 45 wt % based on the total solid weight of the over varnish composition. The cross linker, when present, may be used in amounts from 30 to 50 wt %, such as from 35 to 45 wt % based on the total solid weight of the over varnish composition.

The over varnish composition (which may be referred to as the thermally-curable over varnish composition) may further comprise a catalyst. Any catalyst typically used to catalyse crosslinking reactions between film-forming resins and/or between film-forming resins and cross linkers may be used. Suitable catalysts will be well known to the person skilled in the art. The catalyst may be a non-metal or a metal catalyst or a combination thereof. Suitable non-metal catalysts include, but are not limited to the following: phosphoric acid; blocked phosphoric acid; phosphatised resins such as, for example, phosphatised epoxy resins and phosphatised acrylic resins; CYCAT® XK 406 N (commercially available from Allnex); sulfuric acid; sulfonic acid; CYCAT 600 (commercially available from Allnex); NACURE® 5076 or NACURE 5925 (commercially available from King industries); acid phosphate catalyst such as NACURE XC 235 (commercially available from King Industries); para-toluene sulphonic acid such as Nacure 2547 (commercially available from King Industries); and combinations thereof. Suitable metal catalysts will be well known to the person skilled in the art. Suitable metal catalysts include, but are not limited to the following: tin containing catalysts, such as monobutyl tin tris (2-ethylhexanoate); zirconium containing catalysts, such as KKAT® 4205 (commercially available from King Industries); titanate based catalysts, such as tetrabutyl titanate TnBT (commercially available from Sigma Aldrich); and combinations thereof.

The catalyst, when present, may be used in the over varnish composition in any suitable amount. The catalyst, when present, may be used in amounts of at least 0.001 wt %, such as at least 0.01 wt %, such as at least 0.05 wt %, such as at least 0.1 wt %, based on the total solid weight of the over varnish composition. The catalyst, when present, may be used in amounts up to 10 wt %, such as up to 5 wt %, such as up to 5 wt %, such as up to 3 wt %, such as up to 2 wt %, based on the total solid weight of the overvarnish composition. The catalyst, when present, may be used in amounts from 0.001 to 10 wt %, such as from 0.001 to 5 wt %, such as from 0.01 to 5 wt %, such as from 0.05 to 3 wt %, such as from 0.1 to 2 wt %, based on the total solid weight of the over varnish composition.

The over varnish composition (which may be referred to as the thermally-curable over varnish composition) may comprise other optional materials well known in the art of formulating coatings, such as matting agents, wetting agents, levelling agents, plasticizers, abrasion-resistant particles, anti-oxidants, hindered amine light stabilizers, UV light absorbers and stabilizers, surfactants, flow control agents, thixotropic agents, fillers, organic co-solvents, reactive diluents, grind vehicles, lubricants, and other customary auxiliaries.

The over varnish composition (which may be referred to as the thermally-curable over varnish composition) may provide an over varnish layer (for example as applied to a monobloc aerosol can) having a scratch resistance of at least 10, such as from 10 to 18 or from 12 to 14, revolutions when coated on a substrate and cured thermally. As reported herein, scratch resistance was measured using an Erichsen Hardness Tester 413 instrument. The coating was applied to a tin-coated steel panel and thermally cured at 170° C. for 5 minutes to provide a thickness of 5 to 6 μm. A 10 cm×10 cm square was cut and placed onto the turntable on the instrument. A constant force of 4 N was applied by placing a test tip according to ISO 1518 (diameter=1 mm) in contact with the coated surface. The number of full rotations required to penetrate down to the steel substrate was recorded. The test was carried out three times with 30, 40 and 50 mm diameters of rotation, and the average result of the three tests was taken.

The over varnish composition (which may be referred to as the thermally-curable over varnish composition) may be a single component composition (often referred to as a 1K coating composition) or a multiple component composition, such as a two-component coating composition (often referred to as a 2K coating composition). Such terminology is well known in the art. In a multiple component coating composition, the components are provided separately but introduced to each other (by mixing, for example) prior to application. This could be hours before application, for example up to 8 hours before application or up to 4 hours before application. In some instances, the multiple components may be introduced to each other (such as by mixing) during the application process, such as in line mixing, for example. If the over varnish composition is a multiple component composition, such as a 2-component coating composition, the film-forming resin may be provided in a first component, while other materials may be provided in a further component (such as a second component). For example, the cross linker may be provided in a further component (such as a second component).

The over varnish composition (which may be referred to as the thermally-curable over varnish composition) may be applied to/coated on a substrate by any suitable means such as roller-coating and cured thermally, i.e. such as by heating to a temperature up to 200° C., such as up to 180° C., or such as by heating to a temperature from 80 to 200° C., such as from 120 to 180° C., such as from 160 to 180° C. The thermal curing may be carried out for at least 3 minutes, such as at least 4 minutes, such as at least 5 minutes. The thermal curing may be carried out for up to 10 minutes, such as up to 8 minutes, such as up to 7 minutes. The thermal curing may be carried out for from 3 to 10 minutes, such as from 4 to 8 minutes, such as from 5 to 7 minutes, or 5 minutes.

The disclosure disclosed herein also extends to an article, such as a monobloc aerosol can, coated on at least a portion thereof with an over varnish layer, the over varnish layer being derived from the over varnish composition disclosed herein (which may be referred to as the thermally-curable over varnish composition as described herein).

According to the present disclosure there is provided a substrate, such as an article (such as a monobloc aerosol can) coated on at least a portion thereof with an over varnish layer, the over varnish layer being derived from the over varnish composition as described herein (which may be referred to as the thermally-curable over varnish composition as described herein).

The over varnish composition (which may be referred to as the thermally-curable over varnish composition) may be applied to the substrate by any suitable method. Such methods will be well known to a person skilled in the art. Suitable application methods for the over varnish compositions of the present disclosure include, but are not limited to the following: electrocoating such as electrodeposition; spraying; electrostatic spraying; dipping; rolling; brushing; and the like. The over varnish composition may be applied to the substrate by spraying. Thus, the over varnish composition may be a spray composition. For the avoidance of doubt, by the term ‘spray composition’ and like terms as used herein is meant, unless specified otherwise, that the composition is suitable to be applied to a substrate by spraying, i.e. is sprayable. The over varnish compositions may be applied to a substrate by lamination. For example, a film may be formed from the over varnish composition, which film may subsequently be applied to a substrate (such as a monobloc aerosol can) by lamination thereon.

The over varnish composition (which may be referred to as the thermally-curable over varnish composition) may be applied to any suitable dry film thickness. The over varnish composition may be applied to a dry film thickness up to 15 microns (μm), such as up to 10 μm, such as up to 5 μm, or even up to 1 μm. The over varnish composition may be applied to a dry film thickness from 0.5 to 15 microns (μm), such as from 0.5 to 10 μm, such as from 0.5 to 5 μm, or even from 0.5 to 1 μm.

The over varnish composition (which may be referred to as the thermally-curable over varnish composition) may be applied to a substrate, or a portion thereof, as a single layer or as part of a multi-layer system. The over varnish composition may be applied as a single layer, i.e. to form an over varnish layer. The over varnish composition may be applied to an uncoated substrate. For the avoidance of doubt an uncoated substrate extends to a surface that is cleaned prior to application. The over varnish composition may be applied on top of another paint layer as part of a multi-layer system. For example, the over varnish composition may be applied on top of a primer or an intermediate layer. The over varnish compositions may form a top coat (over varnish) layer. If a further layer is applied to the substrate after the over varnish layer, then this may comprise a coating composition that may be thermally cured at a temperature of up to 200° C., such as from 80 to 200° C.

The over varnish composition (which may be referred to as the thermally-curable over varnish composition) may be applied to any suitable substrate, such as an article, such as a monobloc aerosol can. The substrate may be a metal substrate, such as an aluminium substrate. Suitable examples of monobloc aerosol cans include, but are not limited to, deodorant and hair spray containers. Monobloc aerosol cans may be aluminium monobloc aerosol cans.

The application of various pre-treatments and coatings to substrates such as monobloc aerosol cans is well established. Such treatments and/or coatings, for example, can be used to provide a decorative coating. The over varnish composition may form an over varnish layer over a decorative coating so as to protect the decorative coating from abrasion and/or damage. The over varnish layer may also provide a decorative glossy finish. The over varnish composition may be applied to the exterior of a monobloc aerosol can.

According to the present disclosure there is also provided a use of a combination of a micronized wax and a micronized polysaccharide in an over varnish composition comprising a film-forming resin to provide an over varnish layer having a scratch resistance of at least 10 (such as from 10 to 18 or from 12 to 14) revolutions when coated on a substrate and cured thermally (such as by heating to a temperature up to 200° C., such as up to 180° C. or at temperature of from 80 to 200° C., such as from 120 to 180° C., such as from 160 to 180° C.).

According to the present disclosure there is also provided a method of providing an over varnish layer having a scratch resistance of at least 10 (such as from 10 to 18 or from 12 to 14) revolutions when coated on at least a portion of a substrate, the method comprising:
(i) applying a layer of the over varnish composition as described herein (which may be referred to as the thermally-curable over varnish composition as described herein) to at least a portion of the substrate; and
(ii) thermally curing the over varnish composition (such as by heating to a temperature up to 200° C., such as up to 180° C. or at temperature of from 80 to 200° C., such as from 120 to 180° C., such as from 160 to 180° C.).

According to the present disclosure there is also provided a method of improving the scratch resistance of an over varnish layer on at least a portion of a substrate, the method comprising:
(i) applying a layer of the over varnish composition as described herein (which may be referred to as the thermally-curable over varnish composition as described herein) to at least a portion of the substrate; and
(ii) thermally curing the over varnish composition (such as by heating to a temperature up to 200° C., such as up to 180° C. or at temperature of from 80 to 200° C., such as from 120 to 180° C., such as from 160 to 180° C.).

References to improving scratch resistance refer to an increase in scratch resistance of an over varnish layer formed from a similar over varnish composition that does not comprise a micronized wax and a micronized polysaccharide as described herein.

According to the present disclosure there is also provided a method for coating a monobloc aerosol can on at least a portion thereof with an over varnish layer, the method comprising:
(i) applying a layer of the over varnish composition as described herein (which may be referred to as the thermally-curable over varnish composition as described herein) to at least a portion of the can; and
(ii) thermally curing the over varnish composition (such as by heating to a temperature up to 200° C., such as up to 180° C. or at temperature of from 80 to 200° C., such as from 120 to 180° C., such as from 160 to 180° C.).

### Coated Extruded Plastic Tube and Over-Varnish Composition for Application to an Extruded Plastic Tube

The present disclosure may provide a coated extruded plastic tube. Thus, according to the present disclosure there is provided an extruded plastic tube coated on at least a portion thereof with an over varnish layer, the over varnish layer being derived from an over varnish composition comprising a film-forming resin, a micronized wax and a micronized polysaccharide.

According to the present disclosure there is provided an ultraviolet (UV)-curable over varnish composition comprising a film-forming resin, a micronized wax and a micronized polysaccharide. This over varnish composition is suitable for application to an extruded plastic tube.

The over varnish layer when applied to a substrate, such as an extruded plastic tube, may protect the underlying substrate. The over varnish composition is easy to manufacture and avoids the use of undesirable components such as perfluorooctanoic acid, whilst still providing desirable properties (such as surface slip) in use.

The extruded plastic tube may contain any suitable product, such as a personal care product (such toothpaste or hand cream), foodstuff, paint, adhesive, pharmaceutical ointment and any other product suitable for packaging in an extruded plastic tube. The extruded plastic tube may be formed from any suitable plastic, including low density polyethylene, high density polyethylene, polypropylene, ethyl vinyl alcohol copolymer, or any combination thereof.

The extruded plastic tube can may be coated on at least a portion of an external surface thereof with the over varnish layer. The extruded plastic tube may be coated with a coating layer in addition to the over varnish layer. The over varnish layer may be coated on top of a primer or a basecoat and/or an ink layer. The over varnish layer may form a top coat layer, such as over an ink layer.

The UV-curable over varnish composition comprises a suitable film-forming resin. The over-varnish composition may comprise any suitable film-forming resin for UV cure applications. The film-forming resin may comprise monomeric, oligomeric or polymeric units. The film-forming resin may comprise a functionalised resin such that the resin comprises functional groups operable to cross-link under UV radiation. Suitable such functional groups include (meth)acrylate, olefin (such as vinyl), styryl, epoxy, vinyl ether, oxetane or any combination thereof. The functional groups that are operable to cross-link under UV radiation may be pendant and/or terminal functional groups. The film forming resin may comprise additional functionality in the resin backbone, such that the film forming resin may comprise an acrylic, oligo- or poly-ester, oligo- or poly-ether, urethane, epoxy, or cycloaliphatic epoxy resin.

The film-forming resin may comprise a polyester-(meth)acrylate resin. Herein, the term polyester-(meth)acrylate resin means a material that contains polyester functionality within the resin backbone and two or more (meth)acrylate terminal or pendant functional groups. Herein, this resin may refer to monomeric or oligomeric polyester-(meth)acrylate resins. The polyester-(meth)acrylate resin may comprise any suitable polyester-(meth)acrylate resin. Examples of suitable commercially available polyester-(meth)acrylate resins include those sold under the trade name EBECRYL® available from Allnex such as EBECRYL®1830, EBECRYL® 1871, EBECRYL® 1885, EBECRYL® 4381, EBECRYL® 450, 4744, EBECRYL® 525, EBECRYL® 572, EBECRYL® 657, EBECRYL®800, EBECRYL® 837, EBECRYL® 872, those sold under the trade name Laromer® available from BASF such as Laromer® PE 55 F, Laromer® PE 9024, Laromer® LR 8800, Laromer® PE 56 F, Laromer PE 9079, those available from Arkema such as CN203, CN2035, CN2210, CN2505, CN704, those sold under the trade name Photomer available from IGM Resins such as Photomer 5425, Photomer 5429, Photomer 5433, Photomer 5443, Photomer 5450, those sold under the trade name AgiSyn™ available from DSM Resins such as AgiSyn™ 707, AgiSyn™ 720, AgiSyn™ 9771, those sold under the trade name MIRAMER available from Miwon such as MIRAMER S5257, MIRAMER P2229, MIRAMER PS4500, MIRAMER PS6300.

The term “(meth)acrylate” and like terms are used conventionally and herein to refer to both methacrylate and acrylate.

The film-forming resin may comprise a polyether-(meth)acrylate resin. Herein, the term polyether-(meth)acrylate resin means a material that contains polyether functionality within the resin backbone and two or more (meth)acrylate terminal or pendant functional groups. Herein, this resin may refer to monomeric or oligomeric polyether-(meth)acrylate resins. The polyether-(meth)acrylate resin may comprise any suitable polyether-(meth)acrylate resin. Examples of suitable commercially available polyether-(meth)acrylate resins include those sold under the trade name Laromer® available from BASF such as Laromer® PO 9102, Laromer® PO 43 F, Laromer LR 8982, Laromer® 9013, those sold under the trade name Photomer available from IGM Resins such as Photomer 5850, Photomer 5930, Photomer 9144, Photomer 9145.

The film-forming resin may comprise a urethane-(meth)acrylate resin. Herein, the term urethane-(meth)acrylate resin means a material that contains urethane functionality within the resin backbone and two or more (meth)acrylate terminal or pendant functional groups. Herein, this resin may refer to monomeric or oligomeric urethane-(meth)acrylate resins. The urethane-(meth)acrylate resin may comprise any suitable urethane-(meth)acrylate resin. Examples of suitable commercially available urethane-(meth)acrylate resins include those sold under the trade name EBECRYL® available from Allnex such as EBECRYL®1258, EBECRYL® 1271, EBECRYL®1290, EBECRYL®210, EBECRYL®225, EBECRYL®250, EBECRYL®267, EBECRYL® 270, EBECRYL® 286, EBECRYL® 4100, EBECRYL® 4513, EBECRYL® 8110, those sold under the trade name Laromer® available from BASF such as Laromer® UA 9072, Laromer® UA 9033, Laromer LR 8987, Laromer® UA 9064, those available from Arkema such as CN9001, CN9002, CN9196, CN910A70, CN9900, CN9301, CN925, those sold under the trade name Photomer available from IGM Resins such as Photomer 6010, Photomer 6024, Photomer 6210, Photomer 6582, Photomer 6645, Photomer Aqua 6901, those sold under the trade name MIRAMER available from Miwon such as MIRAMER PU2050, MIRAMER PU2560, MIRAMER PU3000, MIRAMER PU5000NT, MIRAMER PU640, those sold under the trade name AgiSyn™ available from DSM Resins such as AgiSyn™ 242, AgiSyn™ 298, AgiSyn™ 536, AgiSyn™ 670A2, those sold under the trade name NeoRad™ available from DSM Resins such as NeoRad™ U-60, NeoRad™ U-80, NeoRad™ U-6282.

The film-forming resin may comprise an epoxy-(meth)acrylate resin. Herein, the term epoxy-(meth)acrylate resin means a material that contains epoxy functionality within the resin backbone and two or more (meth)acrylate terminal or pendant functional groups. Herein, this resin may refer to monomeric or oligomeric epoxy-(meth)acrylate resins. The epoxy-(meth)acrylate resin may comprise any suitable epoxy-(meth)acrylate resin. Examples of suitable commercially available epoxy-(meth)acrylate resins include those sold under the trade name EBECRYL® available from Allnex such as EBECRYL® 1606, EBECRYL® 2959, EBECRYL® 3105, EBECRYL®3200, EBECRYL®3300, EBECRYL®3420, EBECRYL®3500, EBECRYL® 3600, EBECRYL® 3639, EBECRYL® 3701, EBECRYL® 600, EBECRYL® 6040, those sold under the trade name Laromer® available from BASF such as Laromer® LR 9023, Laromer® LR 8986, Laromer LR 9019, Laromer® EA 9101, those available from Arkema such as CN104, CN110, CN112C60, CN186, CN2003EU, those sold under the trade name Photomer available from IGM Resins such as Photomer 3005, Photomer 3016, Photomer 3052, Photomer 3318, Photomer 3701, those sold under the trade name MIRAMER available from Miwon such as MIRAMER EA2235, MIRAMER EA2259, MIRAMER EA2280, MIRAMER PE210HA, MIRAMER PE250LS, those sold under the trade name AgiSyn™ available from DSM Resins such as AgiSyn™ 1010, AgiSyn™ 9720, AgiSyn™ 2020, AgiSyn™ 9750.

The film forming resin may comprise a silicone (meth)acrylate resin. Herein, the term silicone (meth)acrylate resin means a material that contains siloxane functionality within the resin backbone and two or more (methacrylate) terminal functional groups. Herein, this resin may refer to monomeric or oligomeric silicone (meth)acrylate resins. The silicone meth)acrylate resin may comprise any suitable silicone (meth)acrylate resin. Examples of suitable commercially available silicone (meth)acrylate resins include but not limited to those sold under the trade name DOWSIL™ available from DOW such as DOWSIL™ FA PEPS silicone acrylate, DOWSIL™ FA 4002 ID silicone acrylate, DOWSIL™ FD 4001 CM silicone acrylate, those sold under the trade name EBECRYL® available from Allnex such as EBECRYL® 1360, EBECRYL® 350, EBECRYL® 8890.

The film-forming resin may comprise a monomeric (meth)acrylate resin, i.e. a monomer comprising a (meth)acrylate functional group. The monomeric (meth)acrylate resin may comprise of a central core that is either aliphatic or aromatic in nature. The monomeric (meth)acrylate may additionally or alternatively function as an additional reactive diluent (i.e. in addition or alternatively to functioning as a film-forming resin).

Examples of suitable monomeric (meth)acrylate resins comprising one functional meth(acrylate) group include those sold under the trade name EBECRYL® available from Allnex such as EBECRYL® 113, EBECRYL® 114, EBECRYL® 117, EBECRYL® 118, EBECRYL® IBOA, those sold under the trade name AgiSyn™ available from DSM Resins such as AgiSyn™ 2822, AgiSyn™ 2852, AgiSyn™ 2880, AgiSyn™ 2895, AgiSyn™ 2896, those sold under the trade name MIRAMER available from Miwon such as MIRAMER M1182, MIRAMER M1183, MIRAMER M124, MIRAMER M180, MIRAMER M181, MIRAMER M170, MIRAMER M1051, those sold under the trade name Laromer® available from BASF such as Laromer® LR 8887, Laromer® POEA, Laromer TBCH.

Examples of suitable monomeric (meth)acrylate resins comprising two functional meth(acrylate) groups include those sold under the trade name EBECRYL® available from Allnex such as EBECRYL® DPDGA, EBECRYL® 11, EBECRYL® 130, EBECRYL® 145, EBECRYL® HDDA, EBECRYL® TPGDA, those sold under the trade name AgiSyn™ available from DSM Resins such as AgiSyn™ 2815, AgiSyn™ 2823, AgiSyn™ 2833, AgiSyn™ 2873, AgiSyn™ 2881, those sold under the trade name MIRAMER available from Miwon such as MIRAMER M200, MIRAMER M201, MIRAMER M205, MIRAMER M213, MIRAMER M222, MIRAMER M231, MIRAMER M290, those sold under the trade name Laromer® available from BASF such as Laromer® DPGDA, Laromer TPGDA.

Examples of suitable monomeric (meth)acrylate resins comprising three functional meth(acrylate) groups include those sold under the trade name EBECRYL® available from Allnex such as EBECRYL® 109, EBECRYL® LEO 10501, EBECRYL® OTA 480, EBECRYL® PETIA, EBECRYL® TMPTA, those sold under the trade name AgiSyn™ available from DSM Resins such as AgiSyn™ 2811, AgiSyn™ 2837, AgiSyn™ 2851S, those sold under the trade name MIRAMER available from Miwon such as MIRAMER LR3130, MIRAMER M300, MIRAMER M320, MIRAMER M340, MIRAMER M370, those sold under the trade name Laromer® available from BASF such as Laromer® TMPTA.

Examples of suitable monomeric (meth)acrylate resins comprising four functional meth(acrylate) groups include those sold under the trade name EBECRYL® available from Allnex such as EBECRYL® 1141, EBECRYL® 40, EBECRYL® 45, EBECRYL® 50, those sold under the trade name AgiSyn™ available from DSM Resins such as AgiSyn™ 2844, AgiSyn™ 2887HV-TF, those sold under the trade name MIRAMER available from Miwon such as MIRAMER M4004, MIRAMER M410, MIRAMER M420, those sold under the trade name Laromer® available from BASF such as Laromer® PPTTA.

Examples of suitable monomeric (meth)acrylate resins comprising multiple functional (such as penta- or hexa-functional) meth(acrylate) groups include those sold under the trade name EBECRYL® available from Allnex such as EBECRYL® DPHA, EBECRYL®180, those sold under the trade name AgiSyn™ available from DSM Resins such as AgiSyn™ 2830L, those sold under the trade name MIRAMER available from Miwon such as MIRAMER M500, MIRAMER M600.

The film forming resin may comprise an epoxy resin. Herein the term epoxy resin means a material with epoxy functional groups contained therein. The epoxy functional groups may be in the form of oxirane, glycidyl ether or internal oxirane functional groups. The epoxy resin may comprise a commercially available epoxy resin. Examples of suitable commercially available epoxy resin include those sold under the trade name UviCure® available from Lambson Group Ltd, such as UviCure S105, UviCure S128, those sold under the trade name EPONEX™ available from Hexion such as EPONEX™ 1510, those sold under the trade name HELOXY™ available from Hexion such as HELOXY™ 107, HELOXY™ Modifier 68, those sold under the trade name MIRATE available from Miwon such as MIRATE BDGE, MIRATE LGE, MIRATE TMPGE, those sold under the trade name DENACOL™ available from Nagase America LLC such as DENACOL EX-252, DENACOL FCA-640, those sold under the trade name Omnilane available from IGM Resins such as Omnilane OC1005, Omnilane OC2005, Omnilane OC3005, those sold under the trade name D.E.R. available from Olin™ Epoxy such as D.E.R. 731, D.E.R. 741, those sold under the trade name ARALDITE® available from Huntsman such as ARALDITE® CY 179, ARALDITE® CY 184.

The film-forming resin may comprise an oxetane resin, such as a commercially available oxetane resin. Examples of suitable commercially available oxetane resins include those available from Nagase America LLC such as OXT-101, OXT-121, OXT-221, OXT-212, OXBP, OXIPA, OXMA, HBOX.

The UV-curable over varnish composition may comprise at least 50 wt %, such as at least 70 wt %, such as at least 85 wt % of the film-forming resin based on the total solid weight of the over varnish composition. The over varnish composition may comprise up to 99 wt %, such as up to 98 wt %, such as up to 95 wt % of the film-forming resin based on the total solid weight of the over varnish composition. The over varnish composition may comprise from 50 to 99 wt % of the film-forming resin based on the total solid weight of the over varnish composition. The over varnish composition may comprise from 70 to 98 wt %, such as from 85 to 95 wt %, of the film-forming resin based on the total solid weight of the over varnish composition.

The UV-curable over varnish composition comprises a micronized wax. The micronized wax may comprise any suitable wax, such as a polyolefin wax, a Fischer-Tropsch wax, a polyamide wax, carnauba wax, and/or paraffin wax. The micronized wax may comprise a polyolefin wax, such as polyethylene wax and/or polypropylene wax.

The UV-curable over varnish composition comprises a micronized polysaccharide. The micronized polysaccharide may be in the form of a wax, or may not be a wax. The micronized polysaccharide may comprise a polysaccharide wax. When the micronized polysaccharide comprises a polysaccharide wax, the over varnish composition may comprise an additional micronized wax that does not comprise a polysaccharide. In other words, when the micronized polysaccharide comprises a micronized polysaccharide wax, the over varnish composition further comprises an additional micronized wax, such as a polyolefin wax, a Fischer-Tropsch wax, a polyamide wax, carnauba wax, and/or paraffin wax (for example a polyolefin wax) as described herein.

The micronized polysaccharide may comprise any suitable micronized polysaccharide, such as a polysaccharide comprising glucose units (such as glucose monomers linked by a glycosidic bonds). The micronized polysaccharide may comprise starch, glycogen, cellulose, cellulose, chitosan, chitin, amylose and/or sugar-cane (such as starch, glycogen, cellulose, cellulose, chitosan, chitin and/or amylose).

The weight ratio of the micronized wax to the micronized polysaccharide may be at least 95:5, such as at least 90:10. The weight ratio of the micronized wax to the micronized polysaccharide may be up to 5:95, such as up to 80:20. The weight ratio of the micronized wax to the micronized polysaccharide may be from 95:5 to 5:95, such as from 90:10 to 80:20.

The micronized wax and micronized polysaccharide may be included in the over varnish composition as separate components or as an additive composition that comprises the micronized wax and micronized polysaccharide (for example wherein the micronized wax and micronized polysaccharide are pre-mixed to form the additive composition). The additive composition may comprise the micronized wax and micronized polysaccharide, such as wherein the wax and polysaccharide is processed and/or micronized prior to use to provide the desired particles sizes.

The UV-curable over varnish composition may be solvent-free. Alternatively, the UV-curable over varnish composition may be a solvent-borne composition. When the over varnish composition is a solvent-borne composition, the composition comprises an organic (i.e. non-aqueous) solvent.

When the UV-curable over varnish composition is solvent-borne, the composition may comprise an organic (i.e. non-aqueous) solvent, such that the majority of the solvent in the over varnish composition is an organic solvent, i.e. such that the over varnish composition comprises less than 10 wt %, such as less than 5 wt %, such as less than 2 wt %, of water based on the total weight of the over varnish composition.

The UV-curable over varnish composition may comprise up to 5 wt %, such as up to 10 wt %, up to 15 wt %, up to 20 wt % or up to 50 wt %, of organic solvent based on the total weight of the over varnish composition. The over varnish composition may comprise from 0.5 to 50 wt %, such as from 5 to 20 wt %, such as from 5 to 15 wt %, of organic solvent based on the total weight of the over varnish composition.

Any suitable organic solvent may be used. A suitable organic solvent may comprise an alcohol, ester, ketone, glycol, glycol ether, glycol ether ester, aromatic hydrocarbon, aliphatic hydrocarbon, and/or a derivative thereof, such as diethylene glycol monobutylether, di(propylene glycol) methyl ether, 2-butoxyethanol, 1-methoxy-2-propanol, xylene, toluene, aromatic solvent 100, aromatic solvent 150, 2-butoxyethyl acetate, 2-(2-butoxyethoxy)ethyl acetate, ethyl acetate, n-propyl acetate, n-butyl acetate, isobutyl acetate, n-butyl alcohol, isobutyl alcohol, 1-methoxy-2-propyl acetate, n-propyl alcohol, cyclohexanone, cyclopentanone, methyl-isobutyl ketone, 2-butanone, diacetone alcohol, propylene carbonate.

The UV-curable overvarnish composition may further comprise a photoinitiator. Any suitable photoinitiator may be used. The photoinitiator may comprise oxy-phenyl-acetic acid 2-[2-oxo-2-phenyl-acetoxy-ethoxy]-ethyl ester, oxy-phenyl-acetic acid 2-[2-hydroxy-ethoxy]-ethyl ester, methylbenzoylformate (MBF), benzophenone, and/or trimethylbenzoyl diphenylphosphine oxide (TPO), Diphenylethanedione, 2,2-Dimethoxy-2-phenylacetophenone (BDK). arylsulfonium hexafluorophosphate, bis(4-dodecylphenyl)iodonium hexafluoroantimonate, 2-hydroxy-2-methyl-1-phenylpropan-1-one, 2-Isopropylthioxanthone.

The photoinitiator may be present in the over varnish composition in any suitable amount. The photoinitiator may be used in amounts of at least 1 wt %, such as at least 5 wt %, based on the total solid weight of the over varnish composition. The photoinitiator may be used in amounts of up to 15 wt %, such as up to 10 wt %, based on the total solid weight of the over varnish composition. The photoinitiator may be used in amounts from 1 to 15 wt %, such as from 5 to 10 wt %, based on the total solid weight of the over varnish composition.

The UV-curable over varnish composition may comprise other optional materials well known in the art of formulating coatings, such as defoamers, surface additives, crosslinkers, catalysts, matting agents, wetting agents, levelling agents, plasticizers, abrasion-resistant particles, anti-oxidants, hindered amine light stabilizers, UV light absorbers and stabilizers, surfactants, flow control agents, thixotropic agents, fillers, organic co-solvents, reactive diluents, grind vehicles, lubricants, and other customary auxiliaries.

The UV-curable overvarnish composition may provide an over varnish layer having a desirable surface slip value when coated on a substrate and UV cured. Surface slip values may be measured by a method in which three coated tubes are placed in a triangle formation on a flat plate. The plate is then gradually inclined at an increasing angle until the upper tube starts to slide across the bottom two tubes. The angle of inclination at this point is recorded. A higher angle corresponds to lower surface slip.

The UV-curable over varnish composition is typically a single component composition (often referred to as a 1 K coating composition).

The UV-curable over varnish composition may be applied to/coated on a substrate by any suitable means such as roller-coating and UV cured by exposure to UV radiation. The UV radiation may be applied at a dose of at least 150 mj/cm², such as at least 155 mj/cm². The UV radiation may be applied at a dose of up to 170 mj/cm², such as up to 165 mj/cm². The UV radiation may be applied at a dose of from 150 to 170 mj/cm², such as from 155 to 165 mj/cm². The UV curing may be carried out for any suitable length of time, such as at least 1 second, such as at least 5 second, such as at least 5 minutes. The UV curing may be carried out for up to 10 seconds. The UV curing may be carried out for from 1 to 10 seconds, such as from 5 to 10 seconds.

The disclosure also extends to an article such as an extruded plastic tube coated on at least a portion thereof with an over-varnish layer, the over varnish layer being derived from the UV-curable over varnish composition disclosed herein.

According to the present disclosure there is provided a substrate, such as an article (such as an extruded plastic tube) coated on at least a portion thereof with an over varnish layer, the over varnish layer being derived from the UV-curable over varnish composition as described herein.

The UV-curable over varnish composition may be applied to the substrate by any suitable method. Such methods will be well known to a person skilled in the art. Suitable application methods for the over varnish compositions of the present disclosure include, but are not limited to roller coating and the like. Thus, the over varnish composition may be suitable to be applied to a substrate by roller coating.

The UV-curable over varnish composition may be applied to any suitable dry film 5 thickness. The over varnish composition may be applied to a dry film thickness up to 15 microns (μm), such as up to 10 μm, such as up to 5 μm, or even up to 1 μm. The over varnish composition may be applied to a dry film thickness from 0.5 to 15 microns (μm), such as from 0.5 to 10 μm, such as from 0.5 to 5 μm, or even from 0.5 to 1 μm.

The UV-curable over varnish compositions may be applied to any suitable substrate, such as an article, such as an extruded plastic tube. The substrate may be a plastic substrate, such as a polyethylene or polypropylene substrate. Suitable examples of extruded plastic tubes include, but are not limited to, containers for products in the form of pastes or ointments. Extruded plastic tubes may be polyethylene or polypropylene plastic tubes.

The application of various pre-treatments and coatings to substrates such as extruded plastic tubes is well established (such as by flame- or Corona-treatment). Such treatments and/or coatings, for example, can be used to provide a decorative coating. The over varnish composition may form an over varnish layer over a decorative coating so as to protect the decorative coating from abrasion and/or damage. The over varnish layer may also provide a decorative glossy or matt finish. The over varnish composition may be applied to the exterior of an extruded plastic tube.

According to the present disclosure there is also provided a use of a combination of a micronized wax and a micronized polysaccharide in a UV-curable over varnish composition comprising a film-forming resin to improve the surface slip value of an over varnish layer when coated on at least a portion of a substrate and UV cured.

According to the present disclosure there is also provided a method of improving the surface slip value of an over varnish layer on at least a portion of a substrate, the method comprising:
(i) applying a layer of the UV-curable over varnish composition as described herein to at least a portion of the substrate; and
(ii) UV curing the over varnish composition.

References to improving surface slip value refer to an increase in surface slip value of an over varnish layer formed from a similar over varnish composition that does not comprise a micronized wax and a micronized polysaccharide as described herein.

According to the present disclosure there is also provided a method for coating an extruded plastic tube on at least a portion thereof with an over varnish layer, the method comprising:
(i) applying a layer of the UV-curable over varnish composition as described herein to at least a portion of the tube; and
(ii) UV curing the over varnish composition.

### General

As used herein, unless otherwise expressly specified, all numbers such as those expressing values, ranges, amounts or percentages may be read as if prefaced by the word “about”, even if the term does not expressly appear. Also, the recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

Singular encompasses plural and vice versa. For example, although reference is made herein to “a” film-forming resin, “a” micronized wax, “a” micronized polysaccharide, and the like, one or more of each of these and any other components can be used.

As used herein, the term “polymer” refers to oligomers and both homopolymers and copolymers, and the prefix “poly” refers to two or more. “Including”, “for example” and like terms means “including but not limited to”.

When ranges are given, any endpoints of those ranges and/or numbers within those ranges can be combined within the scope of the present disclosure.

“Including” and like terms means “including but not limited to”. Similarly, as used herein, the terms “on”, “applied on/over”, “formed on/over”, “deposited on/over”, “overlay” and “provided on/over” mean formed, overlay, deposited, or provided on but not necessarily in contact with the surface. For example, a coating layer “formed over” a substrate does not preclude the presence of another coating layer of the same or different composition located between the formed coating layer and the substrate.”

The terms “comprising”, “comprises” and “comprised of” as used herein are synonymous with “including”, “includes” or “containing”, “contains”, and are inclusive or open-ended and do not exclude additional, non-recited members, elements or method steps. Additionally, although the present disclosure has been described in terms of “comprising”, the coating compositions detailed herein may also be described as “consisting essentially of” or “consisting of”. For example, while the disclosure has been described in terms of a coating comprising a+b+c, a coating consisting essentially of and/or consisting of a+b+c is also within the present scope. In this context, ‘consisting essentially of’ means that any additional coating components will not materially affect the effectiveness of the coating.”

The term “alk” or “alkyl”, as used herein unless otherwise defined, relates to saturated hydrocarbon radicals which are straight, branched, cyclic or polycyclic moieties or combinations thereof and may contain from 1 to 20 carbon atoms, such as from 1 to 10 carbon atoms, such as from 1 to 8 carbon atoms, such as from 1 to 6 carbon atoms, or even from 1 to 4 carbon atoms. These radicals may be optionally substituted with a chloro, bromo, iodo, cyano, nitro, —OR¹⁹, —OC(O)R²⁰, —C(O)R²¹, —C(O)OR²², —NR²³R²⁴, —C(O)NR²⁵R²⁶, —SR²⁷, —C(O)SR²⁷, —C(S)NR²⁵R²⁶, aryl or Het substituent, wherein R¹⁹ to R²⁷ each independently represent hydrogen, aryl or alkyl, and/or be interrupted by a oxygen or sulphur atom, or by silano or dialkylsiloxane group. Such radicals may be independently selected from methyl, ethyl, n-propyl, isopropyl, n-butyl, isobutyl, sec-butyl, tert-butyl, 2-methylbutyl, pentyl, isoamyl, hexyl, cyclohexyl, 3-methylpentyl, octyl and the like. The term “alkylene”, as used herein, relates to a bivalent radical alkyl group as defined above. For example, an alkyl group such as methyl which would be represented as —CH₃, becomes methylene, —CH₂—, when represented as an alkylene. Other alkylene groups should be understood accordingly.

The term “alkenyl”, as used herein, relates to hydrocarbon radicals having one or several, such as up to 4, double bonds, which are straight, branched, cyclic or polycyclic moieties or combinations thereof and may contain from 2 to 18 carbon atoms, such as from 2 to 10 carbon atoms, such as from 2 to 8 carbon atoms, such as from 2 to 6 carbon atoms, or even from 2 to 4 carbon atoms. These radicals may be optionally substituted with a hydroxyl, chloro, bromo, iodo, cyano, nitro, —OR¹⁹, —OC(O)R²⁰, —C(O)R²¹, —C(O)OR²², —NR²³R²⁴, —C(O)NR²⁵R²⁶, —SR²⁷, —C(O)SR²⁷, —C(S)NR²⁵R²⁶, or aryl substituent, wherein R¹⁹ to R²⁷ each independently represent hydrogen, aryl or alkyl, and/or be interrupted by an oxygen or sulphur atom, or by silano or dialkylsiloxane group. Such radicals may be independently selected from alkenyl groups include vinyl, allyl, isopropenyl, pentenyl, hexenyl, heptenyl, cyclopropenyl, cyclobutenyl, cyclopentenyl, cyclohexenyl, 1-propenyl, 2-butenyl, 2-methyl-2-butenyl, isoprenyl, farnesyl, geranyl, geranylgeranyl and the like. The term “alkenylene”, as used herein, relates to a bivalent radical alkenyl group as defined above. For example, an alkenyl group such as ethenyl which would be represented as —CH═CH₂, becomes ethenylene, —CH═CH—, when represented as an alkenylene. Other alkenylene groups should be understood accordingly.

The term “ar” or “aryl” as used herein, relates to an organic radical derived from an aromatic hydrocarbon by removal of one hydrogen, and includes any monocyclic, bicyclic or polycyclic carbon ring of up to 7 members in each ring, wherein a ring is aromatic. These radicals may be optionally substituted with a hydroxy, chloro, bromo, iodo, cyano, nitro, —OR¹⁹, —OC(O)R²⁰, —C(O)R²¹, —C(O)OR²², —NR²³R²⁴, —C(O)NR²⁵R²⁶, —SR²⁷, —C(O)SR²⁷, —C(S)NR²⁵R²⁶, or aryl substituent, wherein R¹⁹ to R²⁷ each independently represent hydrogen, aryl or lower alkyl, and/or be interrupted by an oxygen or sulphur atom, or by silano or dialkylsilicon groups. Such radicals may be independently selected from phenyl, p-tolyl, 4-methoxyphenyl, 4-(tert-butoxy)phenyl, 3-methyl-4-methoxyphenyl, 4-fluorophenyl, 4-chlorophenyl, 3-nitrophenyl, 3-aminophenyl, 3-acetamidophenyl, 4-acetamidophenyl, 2-methyl-3-acetamidophenyl, 2-methyl-3-aminophenyl, 3-methyl-4-aminophenyl, 2-amino-3-methylphenyl, 2,4-dimethyl-3-aminophenyl, 4-hydroxyphenyl, 3-methyl-4-hydroxyphenyl, 1-naphthyl, 2-naphthyl, 3-amino-1-naphthyl, 2-methyl-3-amino-1-naphthyl, 6-amino-2-naphthyl, 4,6-dimethoxy-2-naphthyl, tetrahydronaphthyl, indanyl, biphenyl, phenanthryl, anthryl or acenaphthyl and the like. The term “arylene”, as used herein, relates to a bivalent radical aryl group as defined above. For example, an aryl group such as phenyl which would be represented as -Ph, becomes phenylene, -Ph-, when represented as an arylene. Other arylene groups should be understood accordingly.

For the avoidance of doubt, the reference to alkyl, alkenyl, aryl, aralkyl, or alkaralkyl in composite groups herein should be interpreted accordingly, for example the reference to alkyl in aminoalkyl or alk in alkoxyl should be interpreted as alk or alkyl above etc.

All of the features contained herein may be combined with any of the above aspects and in any combination.

For a better understanding of the disclosure, and to show how embodiments of the same may be carried into effect, reference will now be made, by way of example, to the following experimental data.

### EXAMPLES

### Example 1

Water-based over varnish compositions were prepared with the materials shown in Table 1 (amounts given in percent by weight). These compositions are suitable for coating a monobloc aerosol can.

TABLE 1

| | | Comparative | Comparative | | |
|---|---|---|---|---|---|
| MATERIAL | FUNCTION | Composition 1 | Composition 3 | Composition 1 | Composition 2 |
| Italester H28 | Polyester resin | 39.28 | 39.28 | 39.28 | 39.28 |
| Dimethyl ethanolamine | Compatibilizer | 2.83 | 2.83 | 2.83 | 2.83 |
| Cymel 303 | Melamine resin | 19.13 | 19.13 | 19.13 | 19.13 |
| Diethylene glycol | Solvent | 0.61 | 0.61 | 0.61 | 0.61 |
| monobutyl ether | | | | | |
| 2-butoxyethanol | Solvent | 1.42 | 1.42 | 1.42 | 1.42 |
| Nacure 2547 | Catalyst | 0.65 | 0.65 | 0.65 | 0.65 |
| Dodecylbenzenesulfonic | Catalyst | 0.60 | 0.60 | 0.60 | 0.60 |
| acid solution | | | | | |
| Starch* | Starch sample | | 0.10 | 0.06 | 0.01 |
| Lanco SF 1530 TF** | Wax additive (PE) | | | 0.04 | 0.09 |
| BYK 377 | Polysiloxane | 0.15 | 0.15 | 0.15 | 0.15 |
| | additive | | | | |
| BYK 381 | Polyacrylate | 0.50 | 0.50 | 0.50 | 0.50 |
| | additive | | | | |
| BYK 327 | Silicone additive | 1.52 | 1.52 | 1.52 | 1.52 |

*Micronized starch (D50 ≤ 20 μm)
**Micronized polyethylene (D50 ≤ 6 μm)

The over varnish compositions of Table 1 were prepared as follows:
1. To the polyester resin was charged dimethyl ethanolamine. The mixture was stirred at room temperature for 1 minute under moderate shear using a laboratory mixer.
2. Cymel 303 was then charged to the vessel and then stirred for a further 1 minute under moderate shear.
3. All solvents were then charged to the vessel and then stirred for 90 seconds under moderate shear.
4. Both catalysts were charged to the vessel and stirred for 30 seconds under moderate shear.
5. The starch and wax additive were then charged to the vessel—solid particles were dispersed using an impaler blade under high shear for 10 minutes, whereas dispersions were mixed using laboratory mixer under moderate shear.
6. The BYK additives were then added to the vessel and stirred under moderate shear. The coating was then diluted to the appropriate flow cup viscosity of about 100s DIN 4 cup @ 20° C. using water.

The over varnish and basecoats were applied to the appropriate substrate using a Bar Coater Applicator A size 14 applicator was used. The over varnishes were then cured for 5 minutes at 170° C.

### Characterisation of the Overvarnish Composition:

Appearance: a visual check of the sample is carried out and observations recorded.
Sedimentation: the ease at which the starch and wax additive is re-incorporated into the liquid media is recorded.
pH value: for water-based systems, the pH value is checked using a pH electrode and recorded.
Solid content: ISO 3251. The % weight of sample remaining in a 1.0±0.1 g sample size following 1 hour storage at 125° C.

### Characterisation of the Dry/Cured Film:

Coefficient of friction (CoF): ISO 8295:1995. Measured using an Altec 9505A1 instrument. Coating was applied to an aluminium plate (210×297 mm) and cured as set out above. Measurements were taken at room temperature (RT). A 2 kg weight was used at a constant speed of 20″/min over a distance of 11.5 cm. The CoF was determined for the over varnish applied and cured as above.
Gloss: ISO 2813:2014. The gloss of the over varnish was measured using a BYK Micro Tri glossmeter and values recorded for 20°, 60° and 85°. The over varnish was applied to an aluminium plate (210×297 mm) and cured as set out above.
Scratch resistance: Measured using an Erichsen Hardness Tester 413 instrument. The coating was applied to a tin-coated steel panel and thermally cured at 170° C. for 5 minutes to provide a thickness of 5 to 6 μm. A 10 cm×10 cm square was cut and placed onto the turntable on the instrument. A constant force of 4 N was applied by placing a test tip according to ISO 1518 (diameter=1 mm) in contact with the coated surface. The number of full rotations required to penetrate down to the steel substrate was recorded. The test was carried out three times with 30, 40 and 50 mm diameters of rotation and the average result of the three tests was taken.

### Test Results

The above tests were carried out on the over varnish compositions of Comparative Compositions 1 and 3 and Compositions 1 and 2, and also a commercially available, solvent-borne over varnish product (Comparative Composition 2).

TABLE 2
Wet coating

| | Comparative | Comparative | Comparative | | |
|---|---|---|---|---|---|
| Test method | Composition 1 | Composition 2 | Composition 3 | Composition 1 | Composition 2 |
| Appearance | Milky | Clear | Milky | Milky | Milky |
| Sedimentation | N/A | Easily | Easily | Easily | Easily |
| | | stirred in | stirred in | stirred in | stirred in |
| pH value | 8.5 | N/A | 8.5 | 8.5 | 8.5 |
| Solid content | 49 | 48 | 49 | 49 | 49 |
| (%) | | | | | |

TABLE 3
Dry film

| | | Comparative | Comparative | Comparative | | Composition |
|---|---|---|---|---|---|---|
| Test method | | Composition 1 | Composition 2 | Composition 3 | Composition 1 | 2 |
| CoF | RT | OV: 0.080 | OV: 0.068 | OV: 0.09 | OV: 0.0875 | OV: 0.0725 |
| Gloss (20° / 60° / | | 91.6 / 95.4 / 99.0 | 99 / 101 / 100 | 65.9 / 85.5/ 89.8 | 74.5 / 90.2 / 94.5 | 80.0 / 90.0 / 97.2 |
| 85°) | | | | | | |
| Scratch | | 4 | 10 | 7 | 12 | 14 |
| resistance | | | | | | |
| (rotations) | | | | | | |

The scratch resistance of Compositions 1 and 2 was superior to the scratch resistance of Comparative Compositions 1 to 3 (including commercial product Comparative Composition 2).

### Example 2

The over varnish compositions of Table 4 below can be prepared as follows:
1. To the acrylate resin is charged the wax additive and starch sample (if present) using lab mixer with impaler blade under high shear. These are mixed for 10 minutes.
2. Both photoinitiators are charged and stirred for 1 minute under moderate shear.
3. Remaining materials are then charged to the vessel and stirred using a lab stirrer for 2 minutes under moderate shear.
   These compositions are UV-curable and suitable for curing an extruded plastic tube.

TABLE 4

| | | Comparative | Comparative | | | | |
|---|---|---|---|---|---|---|---|
| Material | Function | composition 4 | composition 5 | Composition 3 | Composition 4 | Composition 5 | Composition 6 |
| Laromer PO | Acrylate | 60.00 | 60.00 | 60.00 | 60.00 | 60.00 | 60.00 |
| 77 F | | | | | | | |
| Lanco TF | Wax | 0.50 | | | | | |
| 1780 EF | additive | | | | | | |
| Starch* | Starch | | | 0.45 | 0.40 | 0.35 | 0.30 |
| | sample | | | | | | |
| Lanco SF | PE Wax | | | 0.05 | 0.10 | 0.15 | 0.20 |
| 1530** | additive | | | | | | |
| Benzo- | Photo- | 6.00 | 6.00 | 6.00 | 6.00 | 6.00 | 6.00 |
| phenone | initiator | | | | | | |
| Irgacure | Photo- | 1.00 | 1.00 | 1.00 | 1.00 | 1.00 | 1.00 |
| TPO | initiator | | | | | | |
| BYK-066 | Defoamer | 0.50 | 0.50 | 0.50 | 0.50 | 0.50 | 0.50 |
| Actilane 800 | Surface | 2.00 | 2.00 | 2.00 | 2.00 | 2.00 | 2.00 |
| | additive | | | | | | |
| Tego glide | Surface | 2.50 | 2.50 | 2.50 | 2.50 | 2.50 | 2.50 |
| 410 | additive | | | | | | |
| Trimethylol- | Tri- | 17.50 | 17.50 | 17.50 | 17.50 | 17.50 | 17.50 |
| propane | functional | | | | | | |
| triacrylate | acrylate | | | | | | |
| Laromer | Di- | 10.00 | 10.00 | 10.00 | 10.00 | 10.00 | 10.00 |
| DPGDA | functional | | | | | | |
| | acrylate | | | | | | |

| Material | Function | Composition 7 | Composition 8 | Composition 9 | Composition 10 | Composition 11 |
|---|---|---|---|---|---|---|
| Laromer PO | Acrylate | 60.00 | 60.00 | 60.00 | 60.00 | 60.00 |
| 77 F | | | | | | |
| Lanco TF | Wax | | | | | |
| 1780 EF | additive | | | | | |
| Starch* | Starch | 0.25 | 0.20 | 0.15 | 0.10 | 0.05 |
| | sample | | | | | |
| Lanco SF | PE Wax | 0.25 | 0.30 | 0.35 | 0.40 | 0.95 |
| 1530** | additive | | | | | |
| Benzo- | Photo- | 6.00 | 6.00 | 6.00 | 6.00 | 6.00 |
| phenone | initiator | | | | | |
| Irgacure | Photo- | 1.00 | 1.00 | 1.00 | 1.00 | 1.00 |
| TPO | initiator | | | | | |
| BYK-066 | Defoamer | 0.50 | 0.50 | 0.50 | 0.50 | 0.50 |
| Actilane 800 | Surface | 2.00 | 2.00 | 2.00 | 2.00 | 2.00 |
| | additive | | | | | |
| Tego glide | Surface | 2.50 | 2.50 | 2.50 | 2.50 | 2.50 |
| 410 | additive | | | | | |
| Trimethylol- | Tri- | 17.50 | 17.50 | 17.50 | 17.50 | 17.50 |
| propane | functional | | | | | |
| triacrylate | acrylate | | | | | |
| Laromer | Di- | 10.00 | 10.00 | 10.00 | 10.00 | 10.00 |
| DPGDA | functional | | | | | |
| | acrylate | | | | | |

*Micronized starch (D50 ≤ 20 μm),
**Micronized polyethylene (D50 ≤ 6 μm)

### Characterisation of the Wet Coating:

Appearance: a visual check of the sample is carried out and observations recorded.
Sedimentation: the ease at which the wax additive is re-incorporated into the liquid media is recorded.
Solid content: ISO 3251. The % weight of sample remaining in a 1.0±0.1 g sample size following 1 hour storage at 125° C.

### Characterisation of the Dry Film:

Substrate preparation: UV coatings are applied to flame-treated polyethylene substrate (in the form of a tube) using roller application equipment (or similar device). The target film thickness is 5-7 μm. The coated tubes are then cured under UV light using Uviterno Lab BD-5025 equipment (or similar device).
Surface appearance: The cured surface of the coated polyethylene substrate is visually analysed for any hazing, orange peel, fish eyes or solid particulates.
Gloss: ISO 2813:2014. The gloss of the over varnish is measured using a BYK Micro Tri glossmeter and values recorded for 60° and 85°.
Cross-hatch adhesion: DIN ISO 2409. Briefly, a crosshatch grid is made in the film using a grid comb and then covered with tape (grade TESA 4104 clear). The tape is applied to the film surface with some finger pressure in order to ensure a homogenous attachment of the tape to the scratched film surface. Within 60 seconds of its application, the tape is removed rapidly. The grid area is then checked for removal of the coating from the substrate. The grid area is then checked for removal of the coating from the substrate. The adhesion is scored in accordance with the following scale:
   0: The edges of the cuts are completely smooth. No brims along the hole grid are visible, none of the squares of the grid are detached.
   1: Small flakes of the coating are detached at intersections; less than 5% of the area is affected.
   2: Some flakes of the coating are detached along the edges and/or intersections of the incisions. The area affected is 5-15% of the grid.
   3: The coating has peeled along the edges and on parts of the squares of the grid. The area affected is 15-35% of the grid
   4: The coating has peeled along the edges of the incisions in large strips and some squares are totally detached. The area affected is 35-65% of the grid.
   5: All degrees of peeling and flecking that can be not classified under 4.
MEK rub test: 100 reciprocating rubs are carried out using a 1 kg hammer covered with a double cotton cloth layer soaked in methyl ethyl ketone. After the 100 reciprocating rubs are carried out the cotton wool is checked for colouration and coating removal.
Surface slip: Three coated tubes are placed in a triangle formation on a flat plate. The plate is then gradually inclined at an increasing angle until the upper tube starts to slide across the bottom two tubes. The angle of inclination at this point is recorded. A higher angle corresponds to lower surface slip.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

1. A multi-layer coating system comprising:
i) an undercoat coating layer derived from a UV curable undercoat coating composition, the UV curable undercoat coating composition comprising:
a1) an epoxy material;
b1) a polyol material having a hydroxyl value (OHV) of at least 35 mg KOH/g and/or a diketone-functional material; and
c1) a photoinitiator;
ii) an ink layer disposed directly on the undercoat coating layer, said ink layer being derived from an ink composition, optionally wherein the ink composition is digitally printed; and
iii) optionally, a topcoat coating layer disposed directly on the ink layer, said topcoat coating layer being derived from a topcoat coating composition.

2. The multi-layer coating system according to claim 1, wherein the UV curable undercoat coating composition has a solid content of at least 95 wt % based on the total weight of the composition.

3. The multi-layer coating system according to claim 1, wherein the UV curable undercoat coating composition comprises a polyol material in an amount of at least 2 wt %, such as at least 5 wt %, such as from 5 to 30 wt %, based on the total solid weight of the composition; and/or
wherein the UV curable undercoat coating composition comprises a diketone-functional material such as an acetoacetate-functional material, in an amount of at least 2 wt %, such as at least 5 wt %, such as from 5 to 30 wt %, based on the total solid weight of the composition.

4. The multi-layer coating system according to claim 1, wherein the epoxy material comprises a cycloaliphatic epoxy resin.

5. (canceled)

6. The multi-layer coating system according to claim 1, wherein the photoinitiator comprises a cationic photoinitiator.

7. The multi-layer coating system according to claim 1, wherein the UV curable undercoat coating composition is substantially free of polytetrafluoroethylene (PTFE).

8. The multi-layer coating system according to claim 1, wherein the polyol material, when present, has a hydroxyl value (OHV) of at least 50 mg KOH/g, such as at least 100 mg KOH/g;
and/or wherein the polyol material, when present, has an acid value (AV) up to 10 mg KOH/g;
and/or wherein the polyol material, when present, has a number average molecular weight (Mn) up to 5,000 Da.

9. The multi-layer coating system according to claim 1 wherein the UV curable undercoat coating composition further comprises a polyester material, for example a polyester material having an OHV of less than 35 mg KOH/g, such as up to 30 mg KOH/g.

10. (canceled)

11. (canceled)

12. A plastic package coated on at least a portion thereof with a multi-layer coating system according to claim 1.

13. (canceled)

14. The package according to claim 12, wherein the plastic package comprises polyethylene and/or polypropylene; and/or wherein the plastic package comprises an extruded and/or injection moulded plastic tube.

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. An aluminium package coated on at least a portion thereof with a multi-layer coating system comprising:
i) optionally a primer coating layer, said primer coating layer being derived from a primer coating composition;
ii) an ink layer disposed directly on the aluminium package and/or the primer coating layer, if present, said ink layer being derived from an ink composition, optionally wherein the ink composition is digitally printed; and
iii) an overcoat coating layer disposed directly on the ink layer, said overcoat coating layer derived from a UV curable overcoat coating composition, the UV curable overcoat coating composition comprising:
a2) an epoxy material;
b2) a polyol material and/or a diketone-functional material; and
c2) a photoinitiator.

27. (canceled)

28. The aluminium package according to claim 26, wherein the aluminium package is for use in packaging cosmetics, food products, beverages and/or pharmaceutical products.

29. The aluminium package according to claim 26, wherein the aluminium package is an aluminium monobloc aerosol can and/or tube.

30. The aluminium package according to claim 26, wherein the UV curable overcoat coating composition has a solid content of at least 95 wt % based on the total weight of the composition.

31. The aluminium package according to claim 26, wherein the UV curable overcoat coating composition comprises a polyol material in an amount of at least 2 wt %, such as at least 5 wt %, such as from 5 to 30 wt %, based on the total solid weight of the composition; and/or
wherein the UV curable overcoat coating composition comprises a diketone-functional material such as an acetoacetate-functional material, in an amount of at least 2 wt %, such as at least 5 wt %, such as from 5 to 30 wt %, based on the total solid weight of the composition.

32. The aluminium package according to claim 26, wherein the epoxy material comprises a cycloaliphatic epoxy resin.

33. The aluminium package according to claim 26, wherein the photoinitiator comprises a cationic photoinitiator.

34. The aluminium package according to claim 26, wherein the UV curable overcoat coating composition is substantially free of polytetrafluoroethylene (PTFE).

35. The aluminium package according to claim 26, wherein the UV curable undercoat coating composition comprises a polyol material having a hydroxyl value (OHV) of at least 25 mg KOH/g.

36. The aluminium package according to claim 26, wherein the UV curable overcoat coating composition further comprises a wax, for example a wax comprising a micronized wax and/or a micronized polysaccharide;
and/or wherein the UV curable overcoat coating composition further comprises a reactive diluent, for example reactive diluent comprising an oxetane group.

37. The aluminium package according to claim 26, wherein the UV curable overcoat coating composition further comprises a (meth)acrylate-functional material and, optionally, a free-radical initiator, such as a (meth)acrylate-functional material and a free-radical initiator.
